(19) United States
(12) Patent Application Publication
(10) Pub. No.: US 2024/0380235 A1
(43) Pub. Date: Nov. 14, 2024

(54) DRIVETRAIN INTEGRATED TRACTION-TO-AUXILIARY CONVERTER FOR INVERTER BASED ELECTRIC VEHICLES

(71) Applicants: THE GOVERNING COUNCIL OF THE UNIVERSITY OF TORONTO, Toronto (CA); ELEAPPOWER LTD., North York (CA)

(72) Inventors: Caniggia CASTRO DINIZ VIANA, Toronto (CA); Mehanathan PATHMANATHAN, Toronto (CA); Peter LEHN, Toronto (CA)

(21) Appl. No.: 18/688,243

(22) PCT Filed: Aug. 31, 2022
(86) PCT No.: PCT/CA2022/051317

§ 371 Date: Feb. 29, 2024

Related U.S. Application Data
(60) Provisional application No. 63/239,183, filed on Aug. 31, 2021.

(51) Int. Cl. H02J 7/34; B60L 50/60; B60L 53/22; B60R 16/033; H02M 1/00; H02M 3/335

(52) U.S. Cl. CPC H02J 7/342; B60L 50/66; B60L 53/22; B60R 16/033; H02M 1/0043; H02M 3/33523; B60L 2210/12; H02J 2207/20

(57) ABSTRACT

The proposed system can be utilized in the field of electric and hybrid vehicles, and in particular, provide an improved traction-to-auxiliary converter topology, circuit, and control approach that can be utilized for inverter-based vehicles (e.g., cars, ships, airplanes) that controls charging of different batteries such that an auxiliary vehicle battery (e.g., for headlamps, air conditioning, electrical subsystems) can be charged. A proposed approach is utilized for introducing a controlled phase shift/delay between operation of the inverter(s) for charging the auxiliary vehicle battery.

### CROSS-REFERENCE

This application is a non-provisional of, and claims all benefit to, U.S. Application No. 63/239,183, filed 2021 Aug. 31, entitled: Drivetrain Integrated Traction-to-Auxiliary Converter for Dual Inverter Based Electric Vehicles. This document is incorporated herein by reference in its entirety.

### FIELD

Embodiments of the present disclosure generally relate to the field of electric (EV) and hybrid vehicles (HV), and more specifically, embodiments relate to devices, systems and methods for improved traction-to-auxiliary (T2A) converter topologies, circuits, and control software/approaches that can be utilized for charging auxiliary energy storage devices of dual inverter-based vehicles through power control of the main drive energy storage device(s).

### INTRODUCTION

Modern electric vehicles can have large power requirements to support auxiliary features in the vehicle. These auxiliary features in the vehicle include aspects such as headlamps, air conditioning, heating, or other electronic devices plugged into the vehicle through an auxiliary power outlet (e.g., a 12 V “cigar lighter socket”).

These auxiliary features are provided through an auxiliary energy source, such as an auxiliary battery (although other energy storage device technologies are contemplated), which requires charging. Typically, this auxiliary energy storage is separate from the drive energy sources due to differences in the types and magnitude of energy requirements (e.g., 12 V vs. 400 V). The auxiliary energy storage can be charged during stationary operation of the vehicle, but in some cases, the auxiliary energy storage also needs to be charged during drive operation of the vehicle (e.g., to avoid having the vehicle's air conditioning turn off during a long journey).

Alternate approaches have been contemplated for charging the auxiliary energy storage, including the use of additional or dedicated converter components, dual active bridges, among others. However, these approaches all add undesirable weight, cost, and volume, which are all important factors to reduce as they all impact the feasibility (e.g., range) and environmental footprint of the vehicle.

### SUMMARY

An improved approach for charging the auxiliary energy storage device (e.g., auxiliary battery) in an electric or hybrid vehicle is proposed in various embodiments herein, utilizing the existing traction energy storage devices (e.g., traction batteries) by deliberately introducing a carrier phase shift or a delay between different semiconductor switches in the circuit.

A traction to auxiliary power supply can be thus integrated for the electric vehicles, such that the switching frequency component of the zero-sequence current through the drive machine (usually an underutilized degree of freedom in the drive system) to facilitate power transfer. In lieu of a standalone auxiliary power module, a small transformer and other small passive components can be included. Despite the zero-sequence component, the multi-frequency technique does not impede techniques that facilitate higher drive voltage synthesis, such as third harmonic injection.

The approach can harness switching harmonic energy produced by a single or a dual inverter drivetrain in driving operation, and traction-to-auxiliary (T2A) power transfer can be conducted by utilizing a control strategy to change a modulation to set a magnitude of a zero-sequence component of the switching harmonic, while not interfering with the drive control system. There are different variations proposed for variations where there is a single drive inverter energy storage device as well as variations where there are multiple (e.g., two) drive inverter energy storage devices that are being utilized to charge the auxiliary energy storage device using the phase-shift.

Effectively, the multi-frequency power transfer in the drivetrain can be leveraged, allowing a proposed approach to eliminate an auxiliary power module in electric vehicles by taking advantage of energy harvesting from the drivetrian switching to achieve T2A power transfer. As shown, in a variation, a compensation capacitor, a high-frequency transformer, a diode rectifier, and a CL filter can be added to the drivetrain to implement an example proposed system, validated in simulation and experimental results described below. Embodiments of the approach can operate by controlling the phase-shift between carriers in a drive system modulator, while not interfering with drive controls, while avoiding noticeable interference with the mechanical behavior of the drivetrain, despite leveraging both the traction machine and the traction inverter during driving operation.

In a variation, a method of transferring power from energy storage device or devices to the auxiliary storage device is proposed where the power transfer is controlled by phase-shift between two or more semiconductor power switch carrier (used for gating pulse production), potentially without interfering with the driving operation. In this variation, the series combination of the primary side of a transformer and a compensation capacitor are connected to two points of the drivetrain, which may include terminals of energy storage devices and/or terminals of stator windings, the magnitude of the current on the primary winding of the transformer is monotonically related to the power transfer to the auxiliary storage device, the current on the primary winding of the transformer is the sum of two or more winding or winding sections of the traction motor stator, and/or the secondary side of the transformer is connected to a rectifier, which, in turn, is connected directly or through an optional low pass filter to the auxiliary storage device. This variation includes scenarios with a single battery or energy storage device (e.g., the single inverter drivetrain scenario).

While the phase shift or delay can be used to offset and remove electrical harmonics (e.g., to reduce power quality problems), however, in the proposed approach described herein, instead of attempting to offset and remove electrical harmonics, the approach deliberately introduces harmonics to be produced to facilitate power transfer from the traction inverter energy storage device(s) to the auxiliary energy storage device. The power transfer is through controlling a common-mode electrical characteristic (e.g., common-mode voltage) between the traction inverter energy storage device(s), the common-mode current of the motor with respect to an energy storage device, or the common-mode voltage of different phases of the machine, depending on the proposed variation.

This carrier phase shift or delay causes the auxiliary energy storage device to be charged, and the carrier phase shift or delay is controlled such that the charging characteristics can utilize sensed information relating to the charging status of the auxiliary energy storage device (e.g., as obtained by coupled sensors) in a feedback loop to maintain a desired charging characteristic.

The approach can be provided in the form of an electronic circuit, software or firmware for controlling an electronic circuit, a device housing the electronic circuit and coupled to the electrical systems of a vehicle, or a vehicle including the device and the corresponding electronic circuit that is adapted to utilize phase shifts or delays for charging the auxiliary energy storage device. For example, a drivetrain is proposed that integrates the traction-to-auxiliary power conversion functionality, where a capacitive network and the primary of a transformer are connected to two or more points of the drivetrain, where the two or more points of the drivetrain to which the capacitive network and primary winding of the transformer are connected may involve the drivetrain energy storage device positive terminal, negative terminal, or both, the machine neutral point connections, and/or the machine stator phase windings. Control of the traction-to-auxiliary power conversion can be controlled by phase shift between the carriers used to produce the PWM gating signals used for driving purposes, and control of the traction-to-auxiliary power transfer does not interfere with the torque production, which is otherwise controlled by the drivetrain. In a further variation, control of the drivetrain torque and or speed production does not interfere with the traction-to-auxiliary power transfer.

As described herein, the mechanism can be adapted also as a retrofit to existing vehicles by coupling with their existing traction energy storage devices. Despite using the drivetrain semiconductor switches, the approach can be used both during drive operation as well as standstill operation of the vehicle.

Relative to alternate approaches, the approach described herein for charging the auxiliary energy storage device is adapted to require minimal added circuitry, reducing the need for heavy and expensive power converters and/or electronics present in the vehicles currently in the market. For example, a benefit may be being able to introduce the control approach without requiring addition of active switches, providing an elegant approach for adding T2A functionality to the drivetrain. Moreover, the mass and volume reduction afforded by the proposed approaches may aid in additional range, which may be a significant benefit for EV designers.

The charging is conducted instead using a specific approach for control, controlling of power transfer between the main traction energy storage device or devices and the low voltage auxiliary energy storage device without out any extra active switches, compared to the drivetrain. The carrier phase shift (and/or a gating signal delay) is established between the top and bottom inverter in a dual inverter drivetrain, between different semiconductor switch legs of a drivetrain, or otherwise between semiconductor switching elements within the drivetrain. In some embodiments, from 0 to half of the switching period, the phase-shift monotonically increases the magnitude of the 0-axis voltage. As a result, increasing the phase-shift increases 0-axis currents through the open winding machine stator. Circuit approaches and control circuits are described below as example approaches for reducing error terms (e.g., using PI, PID controllers).

The primary side of a transformer is connected in such a way that its currents is proportional to the 0-axis current through the machine, i.e., the transformer primary winding is connected to each one of the batteries through a capacitive network and the transformer primary current coincides with the sum of the stator phase currents. The secondary side of the aforementioned transformer is connected to the auxiliary battery through a rectifier stage (e.g., rectifier circuit). Therefore, increasing the 0-axis current through the motor increases the power flowing through the transformer, which can be used to control the power flow to the auxiliary battery.

In an embodiment, the electronic circuit is a controller circuit that couples to a sensor monitoring the auxiliary energy, sending gating signals to the inverter energy storage devices that are adapted to control the gating state of phases of each inverter (e.g., a top and a bottom inverter in a dual inverter drive) to establish the phase shift (e.g., by controlling a delay term). The phase shift required to achieve a particular charging characteristic may depend on other factors, such as operating characteristics of the inverters (that may be dependent on speed), such as a modulation index, among others.

The gating signals, for example, could be a pulse-width modulation (PWM) signal, such as a triangular wave (e.g., a sawtooth wave). The gating signals characteristics, except for phase shift and delay between two or more gating signals, may be defined based solely on driving requirements, such that the present solution does not interfere with the driving process. In this example, there can be two gating signals generated, one that is produced using a first carrier wave, and a second gating signal that is produced using a delayed version of the carrier. The delay between the carriers used, along with the PWM technique of choice, to produce these signals can be utilized to directly control the inverter operation to establish the charging of the auxiliary energy storage device.

The controller circuit, may also include other electronic components such as, but are not limited to a capacitive network, an isolation transformer, a rectifier, a filter, a sensor, and a feedback controller (e.g., a proportional integral (PI) controller, or other types of controller, such as a P controller, a PID controller). These electronic components interoperate with one another as additional circuitry that operate between the dual inverter energy storage devices and the auxiliary energy storage device (e.g., a low voltage battery).

A capacitive network (e.g., 4 capacitors) is not necessary in all embodiments, for example, in an alternate embodiment, the energy storage devices can connect to the isolation transformer directly instead. The isolation transformer can be coupled to a rectifier (e.g., a diode-based rectifier), followed by an optional filter (e.g., a LC filter), followed by the auxiliary energy storage device.

In use, the capacitive network, isolation transformer, rectifier, filter, and PI controller interoperate to perform traction to auxiliary charging. In some embodiments, the energy storage devices of the inverters are connected to a terminal on the primary side of the transformer, either directly, or through the capacitive network. In other embodiments, the energy storage device of the drivetrain and the machine neutral point may be connected to the series capacitive network and the primary side of the transformer. In other embodiments, the drivetrain motor stator phase windings may be connected to the capacitive network and transformer. The capacitive network can be adapted to form a resonant tank with the machine phase inductances, and the transformer secondary side can be connected to a rectifier circuit. The transformer leakage inductance can be selected to have a value that is based on the design of the resonant tank.

The device can be implemented in different ways, such as a standalone controller circuit for retrofit on an existing electric or hybrid vehicle, or an integrated device that is integrated directly into existing controller circuits by way of a system on a chip addition. In further embodiments, an electric or hybrid vehicle drivetrain can be provided including the controller circuit for traction to auxiliary charging. In a further embodiment, the electric or hybrid vehicle drivetrain is provided directly in an electric or hybrid vehicle.

In another implementation, gating systems control can be provided through provided software or embedded firmware, such as non-transitory computer readable media storing machine-interpretable instructions, which when executed by a processor, cause the processor to perform a method whereby a phase shift or delay is deliberately introduced to provide for traction to auxiliary charging of an auxiliary energy storage device. In this method, the phase shift or delay can be controlled to effect a desired charging state of the auxiliary energy storage device.

Because the approach can be implemented on an existing motor, drivetrain, or vehicle, a technical benefit arises from an ease of implementation using control approaches (e.g., as one does not need to modify a motor, for example, by adding windings during construction, etc.). Accordingly, a further advantage is not requiring an extensive re-construction of the motor to attain enhanced functionality.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a schematic diagram of an example system with a dedicated T2A dual active bridge charger, illustrative of a method for performing T2A conversion.

FIG. 2 is a schematic diagram of an example system using multiport AC charging with T2A capability with shared transformer and Power Electronic Interface (PEI), illustrative of a method for performing T2A conversion.

FIG. 3 is a schematic diagram of an example system using multiport AC charging with T2A capability and shared PEI, illustrative of a method for performing T2A conversion.

FIG. 4 is a block diagram of the proposed integrated T2A charger based on the dual inverter drivetrain, illustrative of a method for performing T2A conversion, according to some embodiments.

FIG. 5 is a circuit diagram of a possible implementation of FIG. 4 using 4 capacitors and a diode-based rectifier, illustrative of a method for performing T2A conversion according to some embodiments.

FIG. 6 is a schematic diagram of a simplified 0-axis equivalent model of the proposed system, according to some embodiments.

FIG. 7 is a graph, illustrative of experimental results of carrier definition and top-to-bottom phase shift representation.

FIG. 8 is a graph, illustrative of experimental results of the weak dependence of A on modulation angle.

FIG. 9 is a graph, illustrative of experimental results of the maximum applicable voltage per-unit.

FIG. 10 is a process diagram of the proposed control system, according to some embodiments.

FIG. 11 is a graph, illustrative of simulation results of the speed and torque profiles during stand-still operation.

FIG. 12 is a graph, illustrative of simulation results of the modulation index magnitude during stand-still operation.

FIG. 13 is a graph, illustrative of simulation results of the power into the auxiliary, LV energy storage device during stand-still operation.

FIG. 14 is a graph, illustrative of simulation results of the carrier phase shift between top and bottom inverters during stand-still operation.

FIG. 15 is a graph, illustrative of simulation results of the voltage applied to the high voltage side of the transformer during stand-still operation.

FIG. 16 is a graph, illustrative of simulation results of the current through the high voltage side of the transformer during stand-still operation.

FIG. 17 is a graph, illustrative of simulation results of the speed and torque profiles during driving operation.

FIG. 18 is a graph, illustrative of simulation results of the modulation index magnitude during driving operation.

FIG. 19 is a graph, illustrative of simulation results of the power into the auxiliary, LV energy storage device during driving operation.

FIG. 20 is a graph, illustrative of simulation results of the carrier phase shift between top and bottom inverters during driving operation.

FIG. 21 is a graph, illustrative of simulation results of the voltage applied to the high voltage side of the transformer during driving operation.

FIG. 22 is a graph, illustrative of simulation results of the current through the high voltage side of the transformer during driving operation.

FIG. 23 is an example variation on a capacitive network, according to some embodiments.

FIG. 24 is an example variation on a capacitive network, according to some embodiments.

FIG. 25 is an example variation on a capacitive network, according to some embodiments.

FIG. 26 is an example variation on a capacitive network, according to some embodiments. In this variation, there is no filter.

FIG. 27 is an example variation on a capacitive network, according to some embodiments.

FIG. 28 is a circuit diagram showing an example circuit of a proposed circuit topology, according to some embodiments.

FIG. 29 is an equivalent circuit diagram showing toe above circuit of the proposed circuit topology, according to some embodiments.

FIG. 30 is a waveform diagram showing a phase-shift, according to some embodiments.

FIG. 31 is a graph showing the magnitude of the switching frequency component against the phase-shift angle, according to some embodiments.

FIG. 32 shows an example controller for correcting the value of delta, according to some embodiments.

FIG. 33A, 33B, 33C, 33D shows a set of four graphs, where at different time periods, the operation of the device is tracked across a set of speed references, indicating that there is no impact on drive control.

FIG. 34 is a set of photographs showing a physical apparatus implementing the system, according to some embodiments.

FIG. 35 is an output from an oscilloscope, showing the current and waveform readings from an experiment, according to some embodiments.

FIG. 36 is an output from an oscilloscope, showing the current and waveform readings from a second experiment, according to some embodiments.

FIG. 37 is an output from an oscilloscope, showing the current and waveform readings from an experiment during standstill operation of the drive system, according to some embodiments.

FIG. 38 is an output from an oscilloscope, showing the current and waveform readings from a second experiment during standstill operation of the drive system, according to some embodiments.

### DETAILED DESCRIPTION

Recent developments in power processing and energy storage have the potential to decrease electric vehicle (EV) production cost and weight, with the latter being a determining factor of range autonomy. The range and cost of EVs, compared to ICE vehicles, remain two prominent barriers limiting the pace of EV adoption.

Adding to price and weight concerns is the increasing trend in auxiliary load power consumption (e.g., air conditioning, powered conveniences, heated seats, infotainment systems).

Modern car consumers expect greater connectivity, comfort, and computational power. To provide for these features, the power requirements from the Traction-to-Auxiliary (T2A) converter can reach 2.5 kW. This power supplies loads such as headlights, onboard computing systems, air conditioning, and many other subsystems. Consequently, EV's T2A supply solutions grow in cost and weight, potentially undermining the weight savings resulting from the advancements in charging and drivetrain power conversion technology. The resulting increase in weight can reduce vehicle driving range.

A T2A converter topology is proposed that leverages the drivetrain power electronic interfaces (PEIs) present in the dual inverter drivetrain systems. The proposed circuit of some embodiments provide improvements to other approaches, including technical benefits in respect of reduced complexity relative to current solutions, and these technical benefits are achieved by leveraging the PEIs of the drive chain that are already present in the dual inverter drivetrain system and providing an additional control approach to establish a phase shift or a delay. The additional control approach can be implemented in the form of a controller circuit or control software/hardware.

The system can be implemented on a dual-inverter drivetrain without the addition of active switches, thereby providing a cost-effective way to add the T2A functionality. The added circuitry can include, for example, capacitors, an isolation transformer, and a diode rectifier, extensively reducing the T2A system's capital cost and weight, while increasing efficiency. Not all of these devices are necessary, and in a simplest implementation, a controller circuit can be coupled to control a phase shift or a delay.

The system does not require any specific AC charging circuitry, thereby providing a flexible T2A integration. The system does not require any additional switching action in comparison with driving, resulting in 0 or minimal additional expected switching loss when operating driving and T2A modes simultaneously.

The system can utilize a control approach (e.g., control process or control methodology) for the dual inverter drive which allows T2A charging without additional active switches. This approach is based on controlling the phase shift between the two carriers used by the dual inverter drive in response to the requested charging power of the low voltage energy storage device in the electric vehicle. This approach prevents damage of the low voltage energy storage device due to overcharging, and ensures that the auxiliary electrical systems of an electric vehicle (e.g. heating and lighting) are never interrupted due to insufficient charge on the low voltage energy storage device.

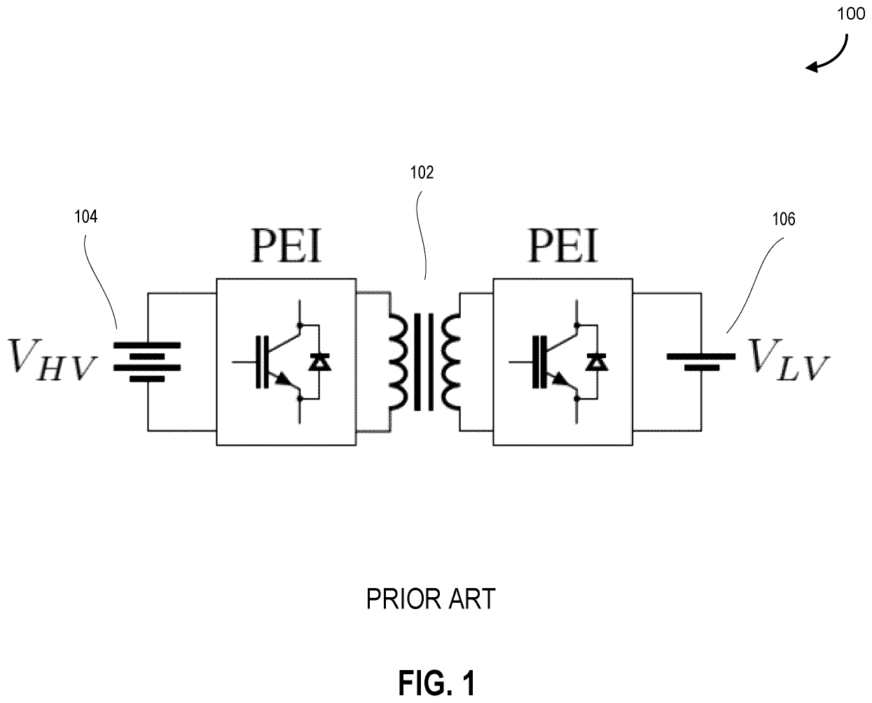

FIGS. 1-3 are examples of alternate approaches from the literature. It is important to note that each of these approaches all require active power electronics and additional dedicated components.

FIG. 1 is a schematic diagram of an example alternate system with a dedicated T2A dual active bridge charger 100, illustrative of a method for performing T2A conversion from Hou and Emadi. The system proposed in FIG. 1 includes a dedicated isolated DC/DC converter 102 (e.g. a dual active bridge) between the High Voltage (HV) energy storage device 104 and Low Voltage (LV) energy storage device 106. The dual active bridge 102 is used exclusively for T2A operation.

The use of dedicated power electronic interfaces and isolation adds significant mass, cost and complexity to the system. Minimizing such additions may significantly improve figures of merit of the associated automotive design.

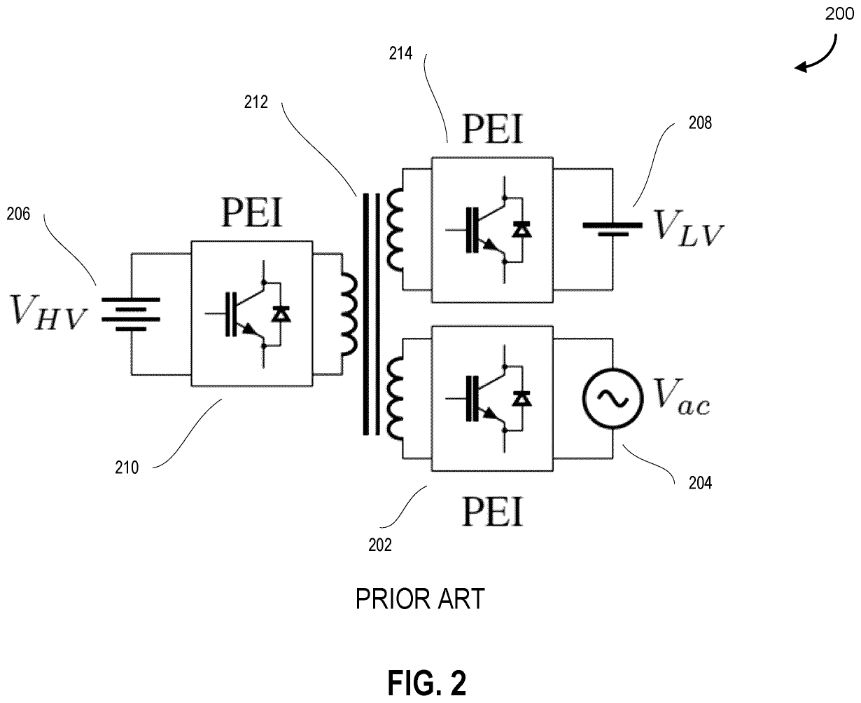

FIG. 2 is a schematic diagram of an example alternate system 200 using multiport AC charging with T2A capability with shared transformer and Power Electronic Interface (PEI), illustrative of a method for performing T2A conversion from Tang et al.

The system 200 leverages part of the AC charging PEI and/or isolation transformer 202 to reduce additional cost and weight of the T2A system. The system 200 implements a multiport converter connecting the AC input 204, the HV energy storage device 206, and the LV energy storage device 208. The resulting structures for T2A conversion are commonly comprised of three stages, a DC/AC traction-to-transformer stage 210, galvanic isolation (transformer) 212, and an AC/DC converter 214 from the transformer to the LV energy storage device. Any one of the three stages may leverage existing circuitry used in the AC charging. However, this system also requires a dedicated power electronic interface to the low voltage battery, resulting in associated mass, cost and an increase in complexity.

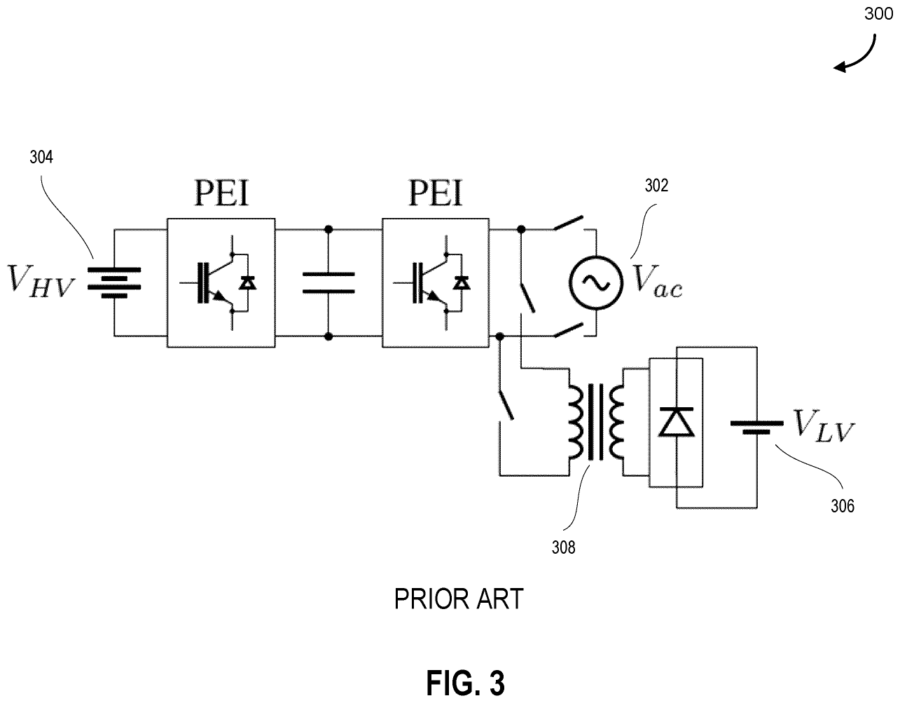

FIG. 3 is a schematic diagram of an example system 300 using multiport AC charging with T2A capability and shared PEI, illustrative of a method for performing T2A charging from Pinto et al. The system 300 implements a multiport converter connecting the AC input 302, the HV energy storage device 304, and the LV energy storage device 306. In contrast to the system proposed in FIG. 2, the system 300 is transformerless, and therefore an isolation transformer 308 is dedicated exclusively for the T2A operation, while only PEIs from the on-board charger (OBC) is leveraged. While in operation, the power electronic interfaces included for ac charging are used for charging of the auxiliary battery. This increases the number of switched conversion stages operating simultaneously, and is expected to increase conversion losses, thereby decreasing vehicle range.

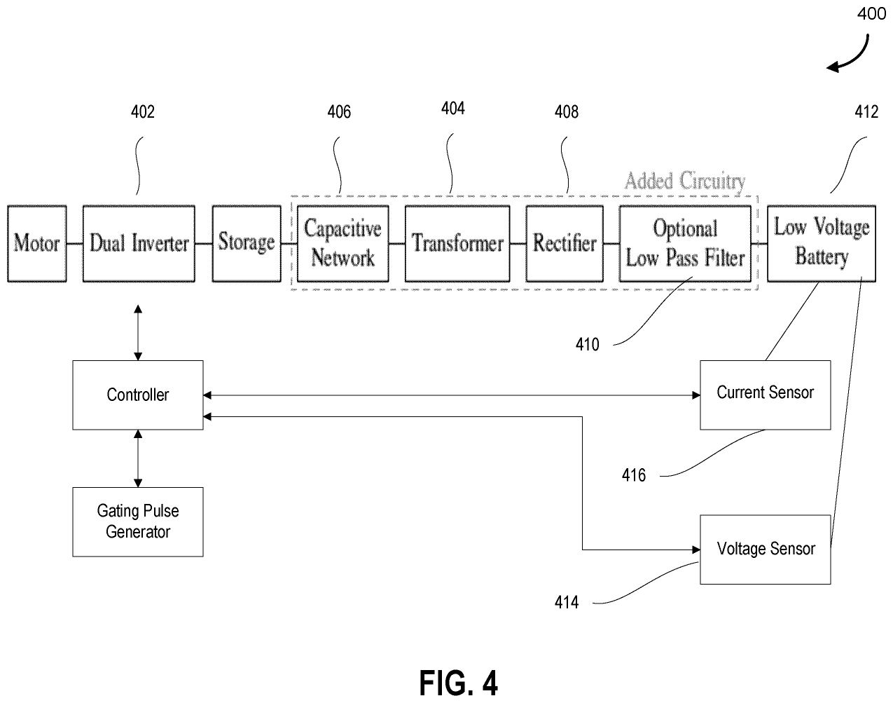

FIG. 4 is a block diagram of the proposed integrated T2A charger 400 based on the dual inverter drivetrain, illustrative of a charger adapted for performing T2A charging, according to some embodiments. As noted herein, variations are also possible with single inverter drivetrains, and the dual inverter drivetrain is provided as a non-limiting example for illustrative purposes.

The system 400 leverages the additional degrees of freedom afforded by using dual inverters 402. In some embodiments, 402 is replaced with single inverters.

In some embodiments, the solution introduced herein can be implemented in conjunction with the dual inverter drivetrain or a single inverter drivetrain. The proposed solution, in these cases, can be practically implemented, for example, by connecting the primary side of a transformer 404 to the dual inverter through a capacitive network 406, with the secondary side of the transformer 404 connected to a rectifier 408, followed by an optional filter 410, followed by the auxiliary LV energy storage device 412. Alternate approaches are possible as some of these electronic elements can be optional (e.g., capacitive network 406, filter 410).

In some embodiments, a voltage sensor 414 and current sensor 416 connected to the LV energy storage device 412 can be implemented in the system 400 to control the phase shift and the gating pulses of the inverters, and to make changes by way of gating pulses to how the inverters would switch compared to relative operations (e.g. drive mode).

The proposed system shown in FIG. 4, has highlighted the components that can be adapted as added circuitry for retrofitting a dual inverter drivetrain.

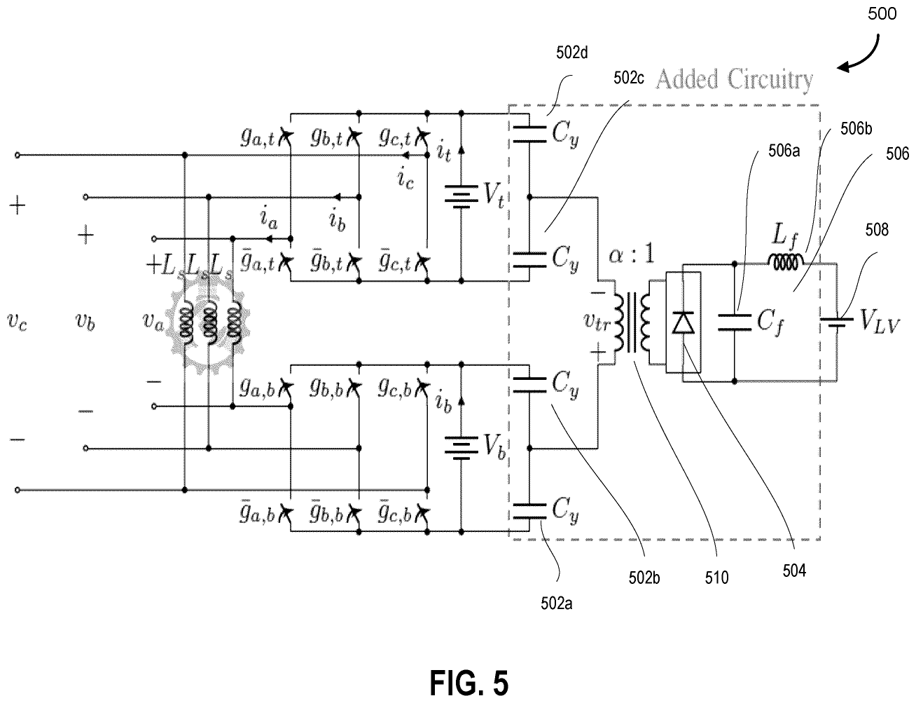

FIG. 5 is a circuit diagram of a proposed implementation 500 of the system 400 using 4 capacitors 502a, 500b, 500c, 500d and a diode-based rectifier 504, according to some embodiments. System 500 also contains a transformer 510, and an optional LC filter 506 placed between rectifier 504 and the auxiliary energy storage device 508. The LC filter is composed of a capacitor 506a and an inductor 506b.

The primary side (e.g., a primary winding) of the transformer is connected to both batteries via a capacitive network. The connection may be done to the anode, cathode, or both of the top battery, and to the anode, cathode, or both of the bottom battery. Moreover, each one of these connections can be achieved using either a capacitor or a short circuit, so long as at least one capacitor is used, allowing the system to form a resonant tank.

Connected this way, the current through the primary side of the transformer is proportional to the 0-axis current of the machine. As a result, a phase-shift established between the top and bottom batteries determines the magnitude of the first harmonic component of the 0-axis voltage through the circuit, which determines the 0-axis current through the circuit, which in turn determines the power flow through the transformer, which determines the power delivered to the auxiliary battery.

Observing the circuit 500, it can be noted that the current into the primary side of transformer 510 equals the sum of the three windings currents (iₐ+i_{b}+i_{c}+), termed the common-mode current.

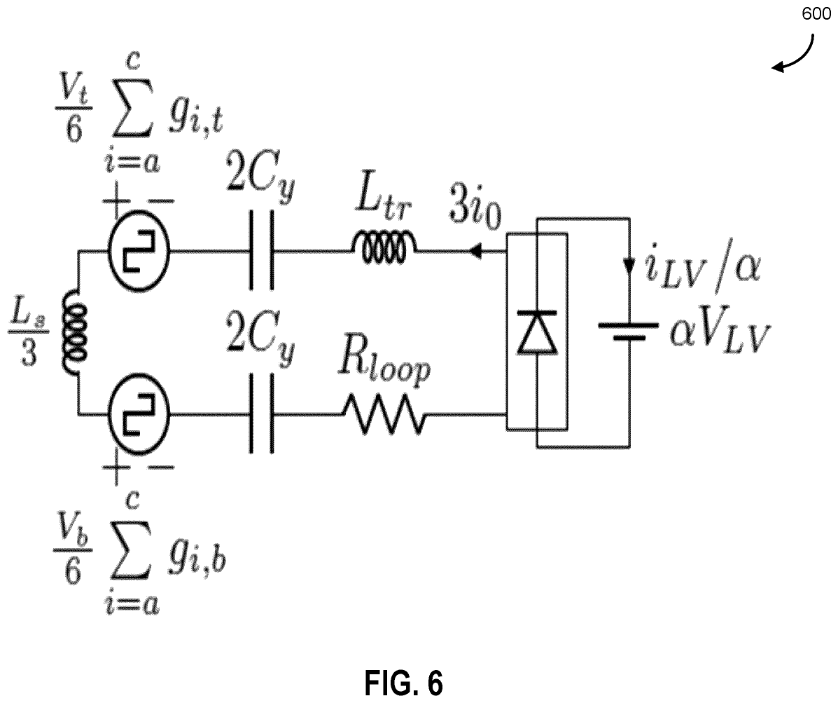

FIG. 6 is a schematic diagram of a simplified 0-axis equivalent model 600 of the proposed circuit 500, according to some embodiments. The common-mode equivalent model 600 of the circuit 500 is derived to allow for simplified analysis of an example of the proposed system.

It is shown that the common-mode current is equivalent to the triple of the 0-axis current. Therefore, the Clarke transformation will be leveraged throughout the following derivations, as this transform decouples the 0-axis current from the flux producing alpha and beta currents. In this derivation, the effects of the low pass filter 506 are neglected, for simplicity.

In system 600, i₀ is the instantaneous average current amongst the three phase windings, defined as

$${i}_{0} = \frac{1}{3} ( {i}_{a} + {i}_{b} + {i}_{c} ) ,$$

Lₛ is the motor's stator winding phase leakage inductance, Vₜ is the top energy storage device voltage, V_{b} is the bottom energy storage device voltage, C_{y} is the capacitance value of the added y-capacitors, Lₜᵣ is the leakage inductance of the step-down transformer, referred to the primary (HV) side, g_{i,t} is the gating state of the ith-phase (i∈ {a, b, c}) of the top inverter; defined to be 1 when the top switch of that inverter is on and −1 when the bottom switch is on, g_{i,b} is the gating state of the ith-phase (i∈ {a, b, c}) of the bottom inverter; 1 when the top switch of that inverter is on and −1 when the bottom switch is on, α is the transformer's step-down ratio, as shown in the proposed system 300, and Rₗₒₒₚ is the aggregated loop resistance, including the equivalent series resistance of the machine phases, batteries, inverter, capacitors, and transformer.

The equivalent 0-axis voltage,

$${v}_{0} = \frac{1}{3} ( {v}_{a} + {v}_{b} + {v}_{c} ) , \qquad ( 1 )$$

is defined to represent the average voltage applied by the dual inverter to the series combination of motor winding leakage inductance and additional circuitry, as defined by the standard Clarke transformation. This voltage can be defined in terms of the gating instantaneous gating signals and the energy storage device voltages as:

$${v}_{0} = \frac{V t}{6} {\sum }_{i = a}^{C} {g}_{i , t} - \frac{V b}{6} {\sum }_{i = a}^{C} {g}_{i , b} \qquad ( 2 )$$

and can be controlled to track the desired 0-axis current i₀.

Although in some embodiments of the system 500 can be operated with different energy storage voltages for each inverter, the energy storage voltages are assumed to be equal in the following derivations for clarity. Under this assumption, the voltage of both energy storage, e.g. batteries, units is defined as

$${V}_{bat} = Δ {V}_{b} = {V}_{c} , \qquad ( 3 )$$

such that the total voltage, v₀, driving the simplified circuit 600 can be rewritten as

$${v}_{0} = \frac{{V}_{bat}}{6} {\sum }_{i = a}^{C} ( {g}_{i , t} - {g}_{i , b} ) . \qquad ( 4 )$$

To facilitate power transfer in the switching frequency, it is necessary to reduce the impedance, allowing for the flow of electrical current. With this objective, the included capacitance, C_{y}, and transformer leakage inductance, Lₜᵣ, can be designed to resonate at the switching frequency, ensuring minimum loop impedance. Equivalently,

$${f}_{sw} = \frac{1}{2 π \sqrt{{C}_{y} ( \frac{{L}_{S}}{3} + {L}_{tr} )}} . \qquad ( 5 )$$

This allows the fundamental 0-axis voltage harmonic produced by the switching of the main traction inverters to generate significant current through the loop, given the low impedance at that frequency, thereby facilitating T2A power transfer. In some embodiments, the system 500 can be designed such that higher order harmonics of the switching frequency do not generate significant currents, as a result of high impedance at the frequency of the higher order harmonics.

The Fourier Series can be used to determine the frequency components of the 0-axis voltage, v₀. In particular, the carrier frequency component, i.e., the component at the switching frequency, can be determined by equation (6),

$${\tilde{V}}_{0}^{( 1 )} = \frac{2}{{T}_{sw}} {\int }_{- \frac{{T}_{sw}}{2}}^{\frac{{T}_{sw}}{2}} {v}_{0} {e}^{- j 2 π {f}_{sw} t} dt , \qquad ( 6 )$$

where the tilde on \tilde{V}₀⁽¹⁾ denotes that this voltage represented by a complex number whose amplitude and phase respectively signifying the amplitude and phase of a sinusoidal voltage, the superscript (1) indicates that this is the Fourier component of the voltage at 1 times the switching frequency f_{sw}, and T_{sw} is the fundamental period associated with f_{sw}.

To control the power transfer in the circuit 500, the magnitude of \tilde{V}₀⁽¹⁾, i.e. |\tilde{V}₀⁽¹⁾|, needs to be controlled. Given the relation shown in (4), it is necessary to know the gating pulse sequencing in order to solve (6), as

$${\tilde{V}}_{0}^{( 1 )} = \frac{2}{{T}_{sw}} {\int }_{- \frac{{T}_{sw}}{2}}^{\frac{{T}_{sw}}{2}} ( {\sum }_{i = a}^{C} ( {g}_{i , t} - {g}_{i , b} ) ) {e}^{- j 2 π {f}_{sw} t} dt . \qquad ( 7 )$$

A possible gating pulse generation is discussed below. Assuming, without loss of generality, that the modulation technique used to drive the electric motor is sinusoidal pulse width modulation (PWM), a phase shift δ can is imposed between the triangular carriers used to generate the gating pulses of the top and bottom inverters to control |\tilde{V}₀⁽¹⁾|. This phase shift is implemented with a Δt delay between carriers of the top and bottom inverters, i.e.

$$δ = ( \frac{Δ t}{{T}_{sw}} ) 2 π . \qquad ( 8 )$$

The system is envisioned to operate during both driving and stand-still drivetrain operation. In conventional driving applications, when the PWM is active, a control system produces a reference voltage, suitable for driving operation. This voltage is used to produce a set of modulated waves, mₐ, m_{b}, and m_{c}. The modulated waves can be written as a space-vector, by use of the Clarke transformation. The modulated wave vector is defined by:

$$\vec{m} = {m}_{d} + j {m}_{q} = M {e}^{j θ} , \qquad ( 9 )$$

where M is the modulation index or, equivalently, the amplitude of the modulated wave vector, typically related to the current speed of the car. M is approximately 0 when the car has 0 speed and monotonically increases as the speed increases, and θ is the angle of \vec{m}, which is dependent on the angle of the voltage space-vector which the driving control system requires to be applied to the motor.

The choice of driving control system is irrelevant for system 500. Additionally, the average over a switching period of the modulation indexes m₀ is 0 in most driving applications, and therefore it is assumed to be 0 in the following derivations.

Applying the inverse Clarke transformation to (9), it can be seen that the modulation indexes used to generate each phase's gating pulses are defined by:

$$[ \begin{matrix}{m}_{a} \\ {m}_{b} \\ {m}_{c}\end{matrix} ] = [ \begin{matrix}M cos ( θ ) \\ M cos ( θ - \frac{2 π}{3} ) \\ M cos ( θ + \frac{2 π}{3} )\end{matrix} ] . \qquad ( 10 )$$

The gating pulses g_{i,t} and g_{i,b} can therefore be generated by comparing the modulated waves with carrier cₜ and c_{b}, respectively:

$$[ \begin{matrix}{g}_{a , t} \\ {g}_{b , t} \\ {g}_{c , t}\end{matrix} ] = sign ( [ \begin{matrix}{m}_{a} \\ {m}_{b} \\ {m}_{c}\end{matrix} ] - {c}_{t} ) , \qquad ( 11 )$$

$$and$$

$$[ \begin{matrix}{g}_{a , b} \\ {g}_{b , b} \\ {g}_{c , b}\end{matrix} ] = sign ( - [ \begin{matrix}{m}_{a} \\ {m}_{b} \\ {m}_{c}\end{matrix} ] - {c}_{b} ) , \qquad ( 12 )$$

where cₜ can be a rising edge saw-tooth, falling edge saw-tooth, triangular wave or another choice of modulating wave. Other carrier signals are possible and contemplated, and the aforementioned are provided as illustrative non-limiting examples.

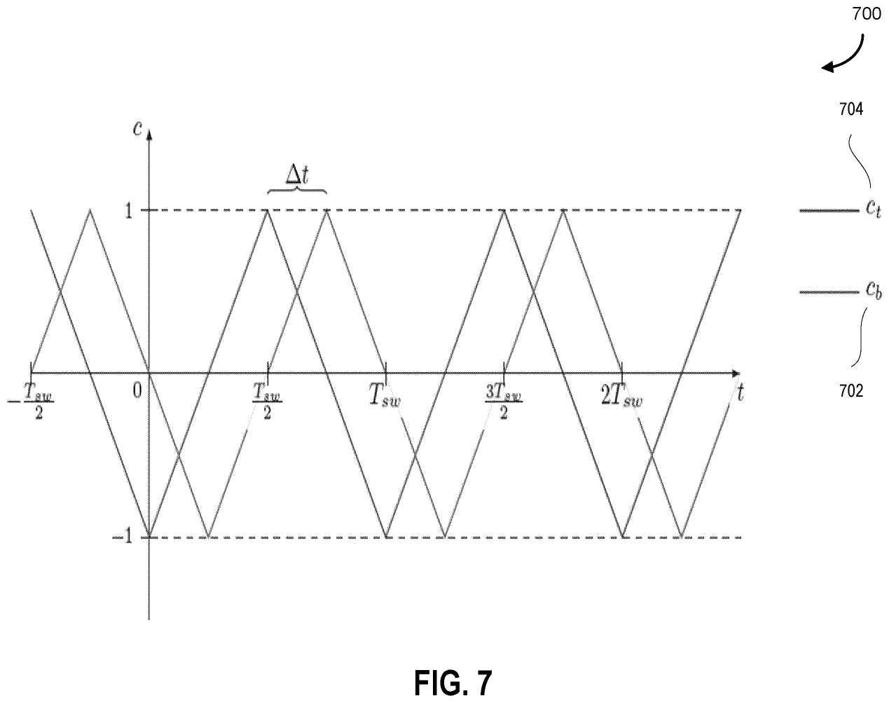

FIG. 7 is a graph, illustrative of experimental results 700 of carrier definition 704 and top-to-bottom phase shift representation 702. For non-limiting illustrative purposes, cₜ is assumed to be a triangular wave, with frequency f_{w}, duty cycle of 50% and has a range between −1 and 1, and c_{b} is a delayed version of the carrier, which is used to generate the gating pulses used to drive the bottom inverter, as previously discussed, i.e.,

$${c}_{b} ( t ) = {c}_{t} ( t - Δ t ) . \qquad ( 13 )$$

This choice of carrier is common in triangular PWM applications.

Once, the gating pulses are defined, based on the choice of carrier and modulated waves, the magnitude of the fundamental frequency component of the voltage v₀ can be written as a function of the modulation index, M, angle θ and the carrier phase-shift, δ as

$$\vert {\tilde{V}}_{0}^{( 1 )} \vert = \frac{4 {V}_{bat}}{3 π} [ {\sum }_{i = - 1}^{1} cos ( \frac{M π}{2} cos ( θ + i \frac{2 π}{3} ) ) ] \vert sin ( \frac{δ}{2} ) \vert . \qquad ( 14 )$$

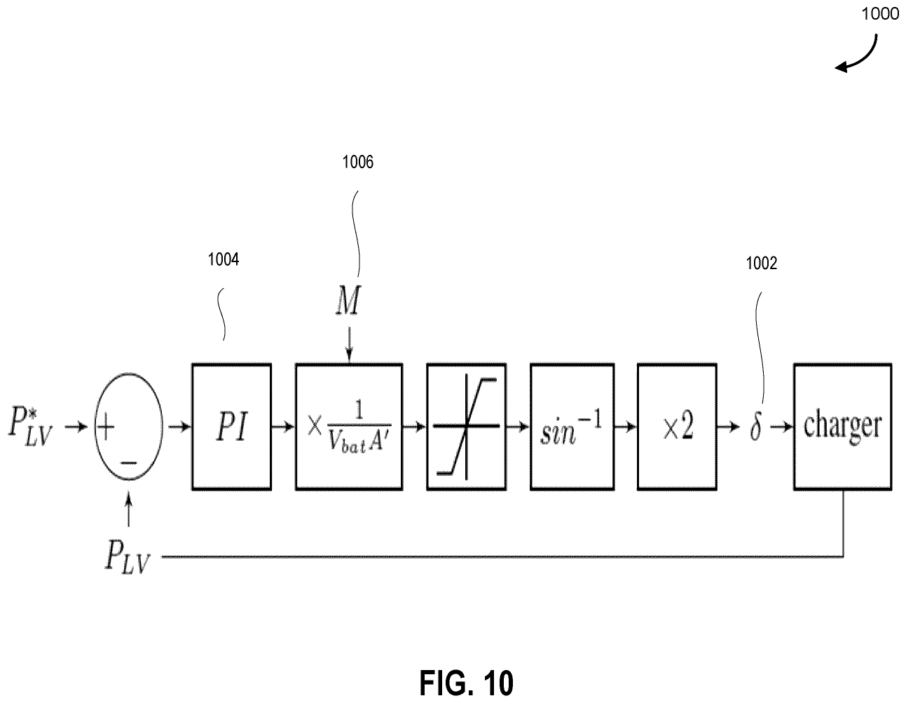

An example proposed approach for control is described below where: (i) the system is adapted to take M and theta into consideration using equation (15), but theta less significant and a simplified equation can be used which does not consider theta, see (16); (ii)—the charging power is controlled by controlling the voltage to achieve a certain power and/or current, as described in FIG. 10.

It is important to note that the approach does not control theta nor M, as these are the variables used for driving. i.e., the driving control determines what their values should be and the system utilizes the information of these values (e.g., as provided by received data sets relating to the operation of the vehicle, for example, from a speedometer, a tachometer, a GPS device) to determine the appropriate phase-shift to be applied. One of the objectives is to not interfere with the driving operation (not change M nor theta).

The maximum attainable amplitude of |\tilde{V}₀⁽¹⁾|, can be defined as A(M, θ)V_{bat}, where A(M, θ) is a function of the modulation index magnitude and angle, given by

$$A ( M , θ ) [ 1 𝓅t ] = Δ \frac{\vert {\tilde{V}}_{0}^{( 1 )} \vert}{{V}_{bat} \vert sin ( \frac{δ}{2} ) \vert} = \frac{4}{3 π} {\sum }_{i = - 1}^{1} cos ( \frac{M π}{2} cos ( θ + i \frac{2 π}{3} ) ) . \qquad ( 15 )$$

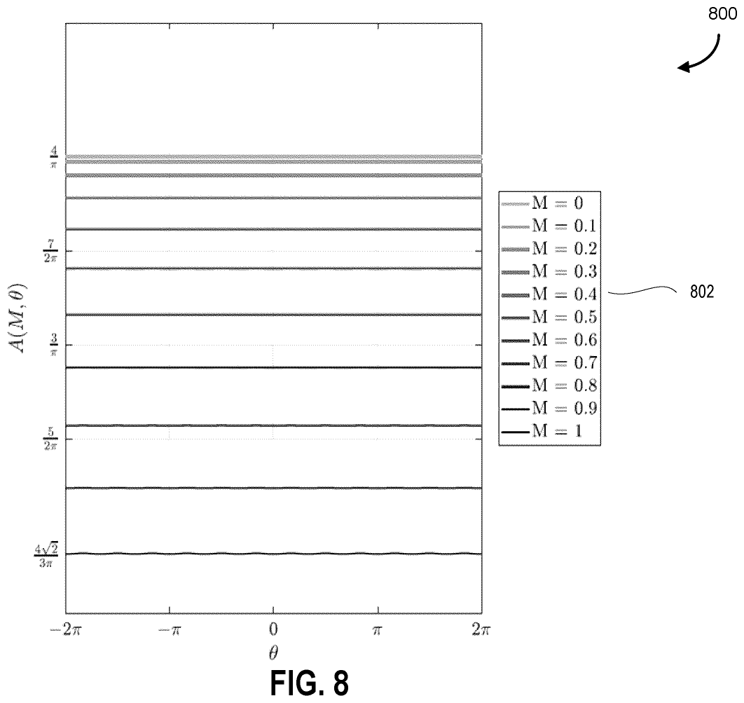

While the function A(M, θ) is mathematically dependent on both modulation index magnitude M and the angle θ, the dependence on the angle can be neglected. To demonstrate this, FIG. 8 is a graph 800 which shows the function A(M, θ) plotted with respect to the modulation angle θ for several values of modulation magnitude 802. Note that for every value of M, the graph 800 is approximately a horizontal line, suggesting the function A(M, θ) barely changes due to changes of modulating wave angle, θ.

Therefore, it is possible to approximate the function A, which describes the maximum applicable voltage as given a suitable choice of carrier phase shift, δ, as being dependent only on the modulation magnitude M,

$$A ( M , θ ) \approx {A}^{′} ( M ) = \frac{4}{3 π} ( cos ( \frac{M π}{2} ) + 2 cos ( \frac{M π}{4} ) ) \qquad ( 16 )$$

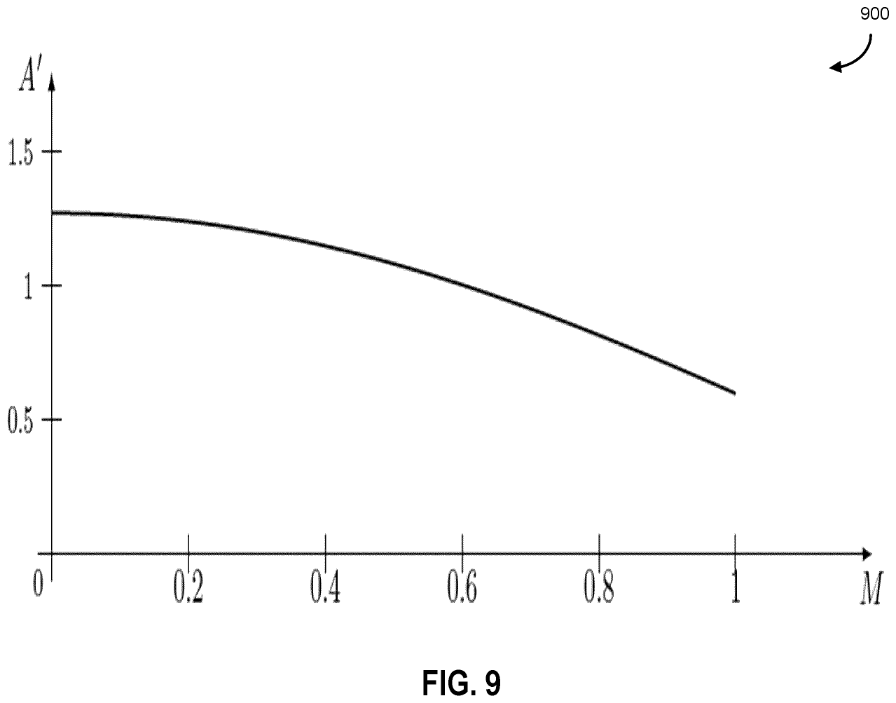

FIG. 9 is a graph 900, illustrative of experimental results of the maximum applicable voltage per-unit. Graph 900 plots the function described in (16), and varies between

$$\frac{4 \sqrt{2}}{3 π} and \frac{4}{π} .$$

Therefore, the magnitude of the 0-axis voltage can be evaluated as:

$$\vert {\tilde{V}}_{0}^{( 1 )} \vert = {A}^{′} ( M ) \vert sin ( \frac{δ}{2} ) \vert {V}_{bat} , \qquad ( 17 )$$

with

$$\frac{4 \sqrt{2}}{3 π} \leq {A}^{′} ( M ) \leq \frac{4}{π} .$$

The maximum applicable voltage may be taken into consideration when designing the system, to ensure the system can meet the power specifications even in the hardest power transfer scenario, i.e. when M=1.

The modulation index tends to increase approximately proportionally to the machine speed, for instance, at rest the modulation index may be zero, while at rated speed the modulation index may be 1. As a consequence, to deliver the same LV energy storage device charging power, the system is expected to apply a higher value of phase-shift when operating at higher driving speeds than when it operates at low speeds.

The rectified sinusoidal current into the low voltage auxiliary energy storage device 508 can have a significant harmonic content. To address this, an optional LC low pass filter 506 can be placed after the rectifier 504. The LC filter behaves as a short for low frequencies and DC and as progressively higher impedance to higher frequencies. To this end, the high frequency of the current waveform can help to reduce the filter cost. The capacitor 506a is 20 mF, 12 V, while the inductor 506b is only 100 nH, and may be implemented leveraging parasitic inductances of the wires connecting the rectifier 504 to the LV energy storage device 508.

The auxiliary low voltage energy storage device charger operates regardless of whether the car is in driving or stand-still mode. As such, the control system must ideally be able to operate without disturbing the driving controls. For instance, if the T2A operation makes driving the vehicle impossible or difficult, the solution may not be desired. The control system may take variables from the driving control into consideration. The modulation index, M, is particularly relevant, as it has some affect in the amplitude of the applied voltage, as shown in equations (16) and (17).

FIG. 10 is a process diagram of the proposed control system 1000, according to some embodiments. The proposed control paradigm is to modify the carrier phase shift, δ 1002. In 1000, the proposed system utilizes a PI controller 1004 to determine the voltage that should drive the circuit 500 in order to zero the power error eₚ, takes into consideration the current modulation index 1006, as set by the driving control system, and determines the appropriate carrier phase shift δ 1002 to be used. Variations are possible, and different, similar, additional, or less process blocks can be implemented.

Simulations are conducted to verify the system operation during stand-still and driving conditions. In the two sets of simulation results presented in this section, conventional techniques are used to control the driving operation and ensure the system follows a reference speed. The speed control system, its architecture, and its design are sufficiently discussed in the literature and are therefore outside of the scope of this paper. The T2A control system ensures the proper functionality of the LV battery charging stage. The purpose of this analysis is to show that the T2A operation does not affect the driving control system. The simulations in this section use the circuit 500, implemented in a permanent magnet synchronous machine. The simulation parameters are shown in Table 1.

TABLE 1
Parameters used in simulation.

| Description | Symbol | Value | |
|---|---|---|---|
| Traction Batteries' Voltage | V_{batt} | 400 | V |
| Machine Phase Inductances | L_{S} | 0.53 | mH |
| Switching Frequency | f_{sw} | 10 | kHz |
| Vehicle Moment of Inertia | J | 0.18 | kgm² |
| Vehicle Friction Coefficient | B | $708 \frac{µNms}{rad}$ | |
| Auxiliary Battery Voltage | v_{LV} | 12 | V |
| Transformer Leakage Inductance | Lₜᵣ | 330 | μH |
| Referred to HV Side | | | |
| Y Capacitor | C_{y} | 500 | nF |
| Turns Ratio | α | $5.25 \frac{V}{V}$ | |
| Auxiliary Filter Capacitance | C_{f} | 4.7 | mF |
| Auxiliary Filter Inductance | L_{f} | 100 | nH |

The first simulation is conducted with the car at rest. In this case, the driving control is operating in neutral mode, i.e., the inverters are switching, but develop 0 torque. This configuration is referred to as stand-still mode throughout this section.

The reference power into the auxiliary battery is initialized as 0 W. This simulation comprises the following 3 transients:
1. at time t=0 s, the reference power is set to P_{LV}*=2.4 kW,
2. at time t=0.3 s the reference power P_{LV}* is set back to 0 W,
3. at time t=0.6 s the reference power P_{LV}* is set back to 2.4 kW.

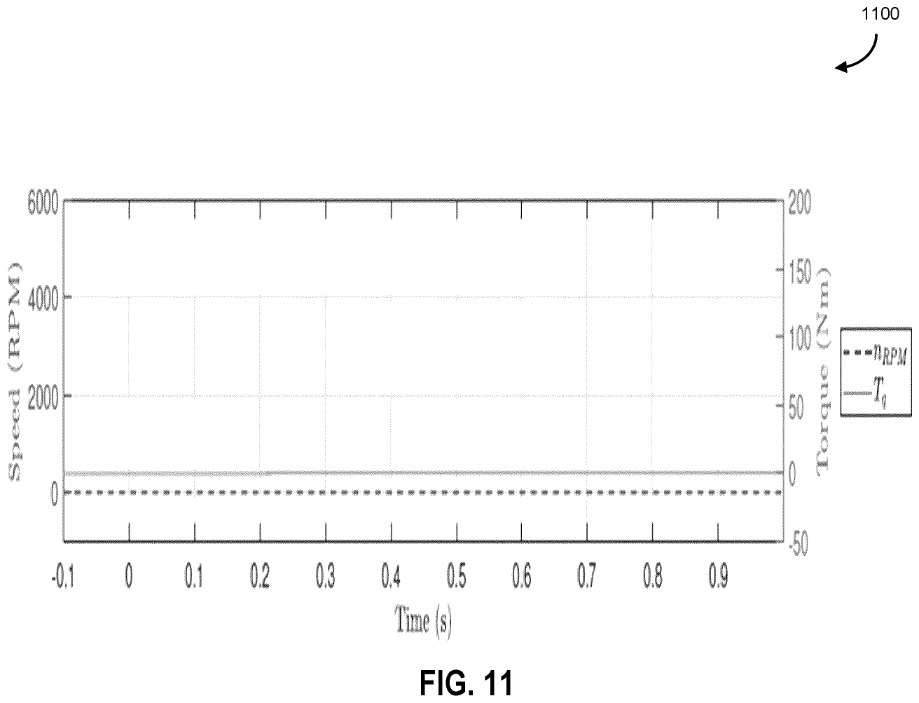

The objective of the system during this simulation is to track the reference power into the auxiliary LV battery 508, P_{LV}*, without disturbing the driving system, i.e., without causing motor torque. The speed and torque waveforms developed during this simulation are shown in graph 1100 of FIG. 11. No torque or speed disturbance is observed.

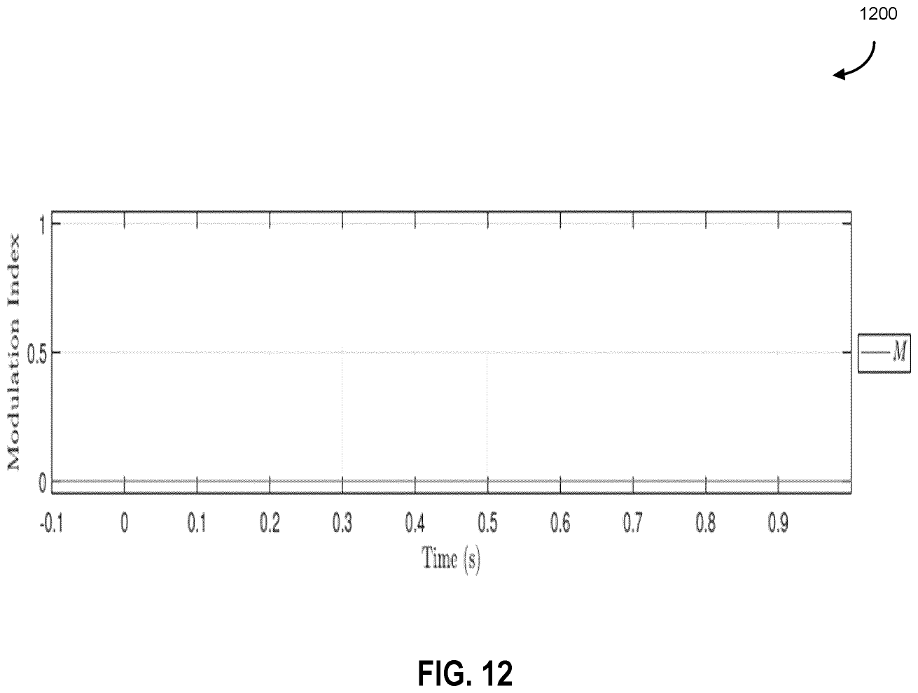

During this operation, the modulation index, M is also recorded. As discussed previously, the modulation index is closely related to the motor speed. The modulation index is approximately proportional to the machine speed. As a result, the modulation index is shown in graph 1200 of FIG. 12 to be approximately 0 during stand-still operation.

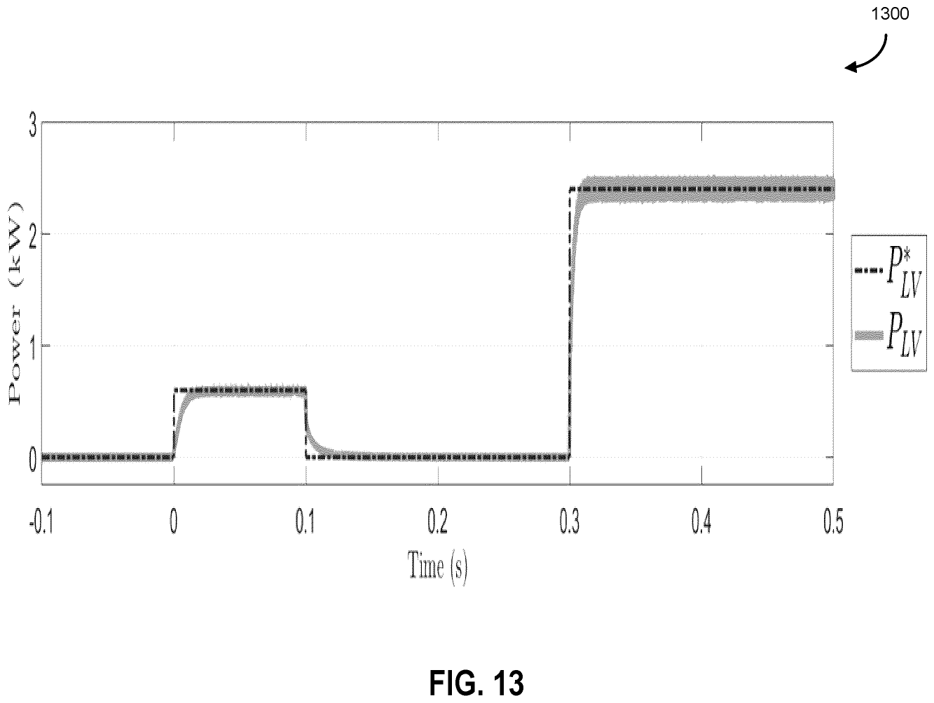

While the system is kept switching in stand-still, the control system 1000 tracks the LV battery power reference. The power reference signal is shown in graph 1300 in FIG. 13 as the black dotted (sharper) trace, and it follows the previously mentioned transients. The actual LV battery power is shown as the red (fuzzier) trace on the same figure. The value P_{V} is comprised of a DC component (average value) and a high frequency oscillation. The DC component tracks the power reference, as a result of the controller action.

The high frequency component is proportional to the DC component magnitude, and arises as a result of the rectification of the AC current through the transformer. The reduction of the high frequency AC ripple is done via the LC filter.

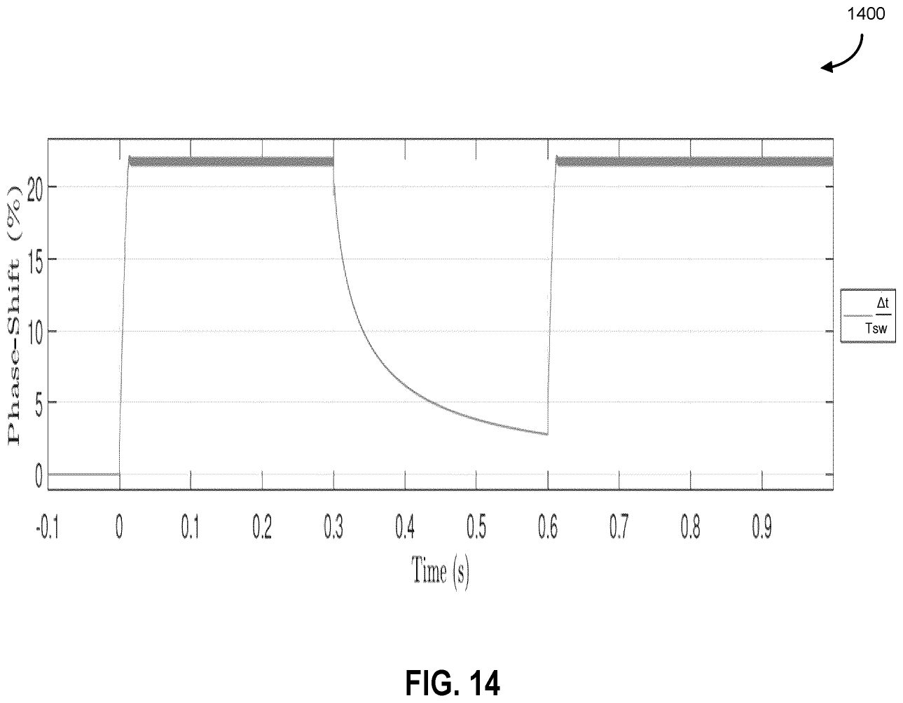

The mechanism used by the controller 1000 to track the power reference is a carrier phase-shift, as illustrated in graph 700. The carrier phase-shift % Δt is shown in graph 1400 in FIG. 14. As the power reference is increased, at time t=0 s, the phase-shift 1002 is raised to approximately 22% of the switching period. As the power reference is matched by the DC value of the actual battery power, the phase-shift 1002 stops increasing and is kept constant by the PI controller 1004. As the power reference is reduced to 0 W at time t=0.3 s, the phase-shift 1002 drops.

It can be observed that the phase-shift 1002 does not need to reach exactly 0 to stop auxiliary power transfer. This is a result of equation (17). A sufficiently low value of Δt, or equivalently, of δ, results in a lower voltage magnitude than the reflected battery voltage. As a result, all current through the transformer ceases, consequently reducing the low voltage battery charging power to 0.

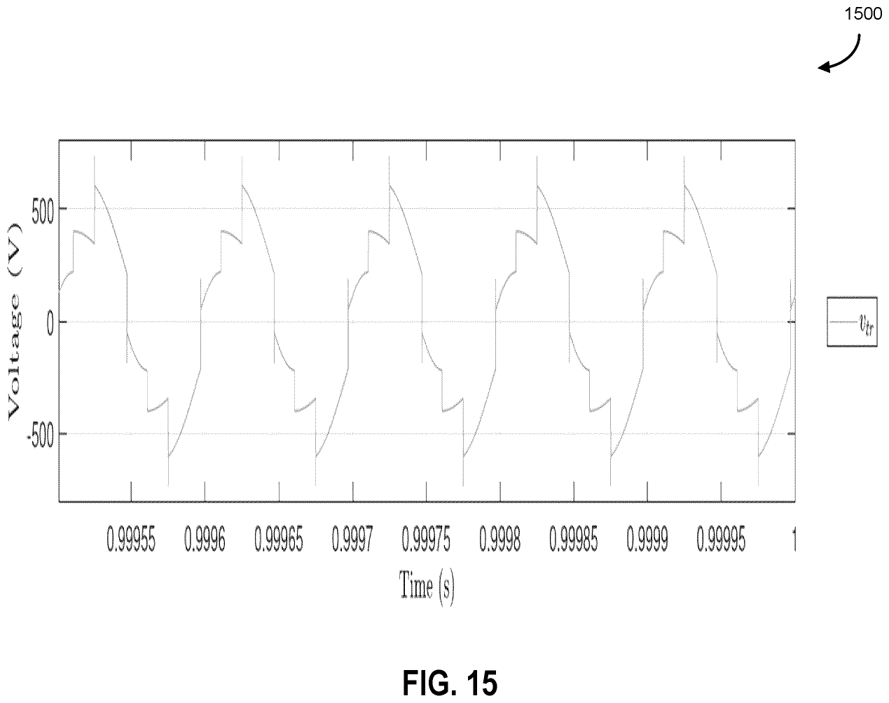

As a result of the phase-shift 1002, a voltage with a significant frequency component at the switching frequency, f_{sw}=10 kHz, arises across the transformer high voltage terminals. This voltage waveform 1500 is presented in FIG. 15.

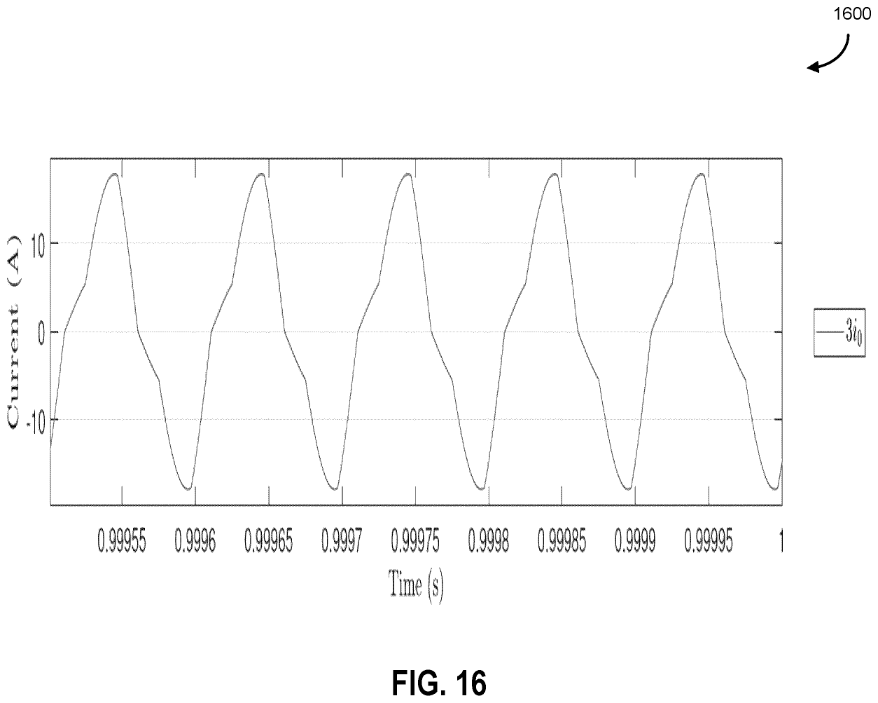

As a result of the voltage generated across the transformer, current arises on the primary of the transformer. This current can be represented as 3i₀ and is equivalent to the sum of the currents through the machine windings. The current 3i₀ is shown in graph 1600 on FIG. 16. This waveform also has a significant frequency component at the switching frequency.

The standing-still simulation results meet the objective, i.e., track the reference power and not cause spurious torque.

Another scenario is simulated to demonstrate the simultaneous driving and T2A operation. In this case, the driving system operates in speed control mode. This simulation includes 4 transients:
1. at time t=0 s, the speed reference of the driving system is set to 5000 RPM,
2. also at time t=0 s, the reference power P_{LV}* is set to 2.4 kW
3. at time t=0.3 s the reference power P_{LV}* is set back to 0 W,
4. at time t=0.6 s the reference power P_{LV}* is set back to 2.4 kW.

The reference LV battery charging power transients performed in this simulation are identical to what is done in the stand-still simulation. However the simultaneous T2A and driving operation provides further insight on the interaction of control system 1000 between both systems.

In particular, this analysis showcases an acceleration during T2A operation, between 0.3 s and 0.6 s. Moreover, the system demonstrates both a power step up and step down transients with the vehicle operating near rated speed.

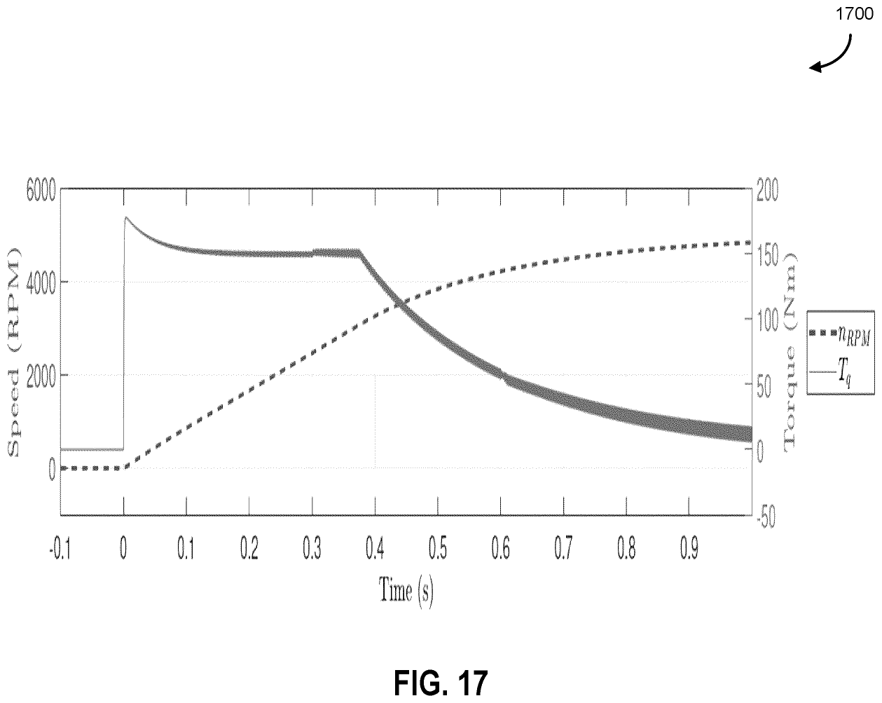

As the speed reference step is applied, at time t=0 s, the speed controller applies torque to the machine, with the objective of raising the motor speed. The torque is kept at the maximum applicable value for some time. As the speed approaches the reference speed, around time t=0.38 s, the torque is slowly reduced, causing the speed to rise with a less steep slope. The torque and speed developed through this simulation are shown in shown in graph 1700 of FIG. 17, and match the expected behavior of a speed controlled system without the T2A functionality. This result suggests no significant disturbances to the driving system is caused by the T2A steady-state operation nor the T2A transients.

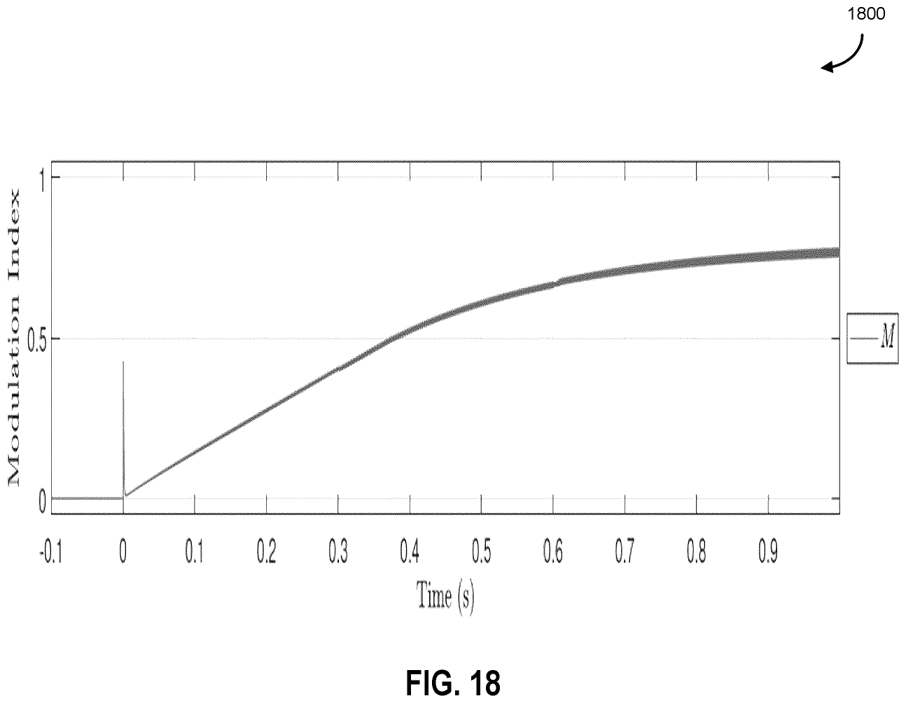

As the machine accelerates, the modulation index rises to ensure the voltage applied to the motor windings meets the back emf caused by rotor speed. The modulation index developed during this simulation in shown in shown in graph 1800 of FIG. 18.

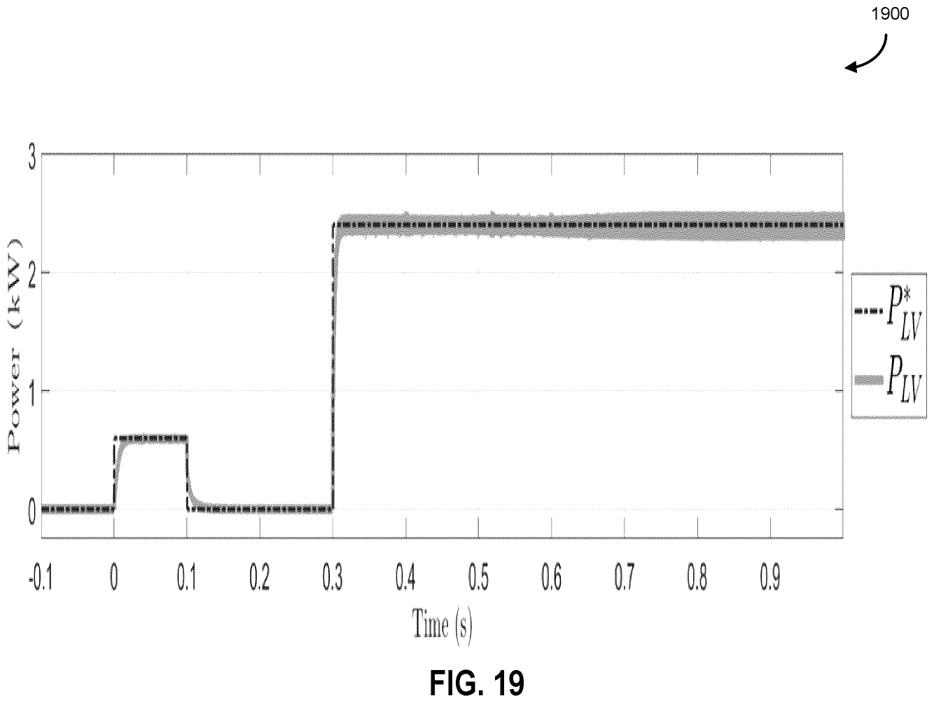

The power into the low voltage battery operates very similarly to what is observed in the stand-still case. As the power reference moves, the actual charging power into the auxiliary battery tracks the reference. The power behavior during the driving simulation is shown in shown in graph 1900 of FIG. 19.

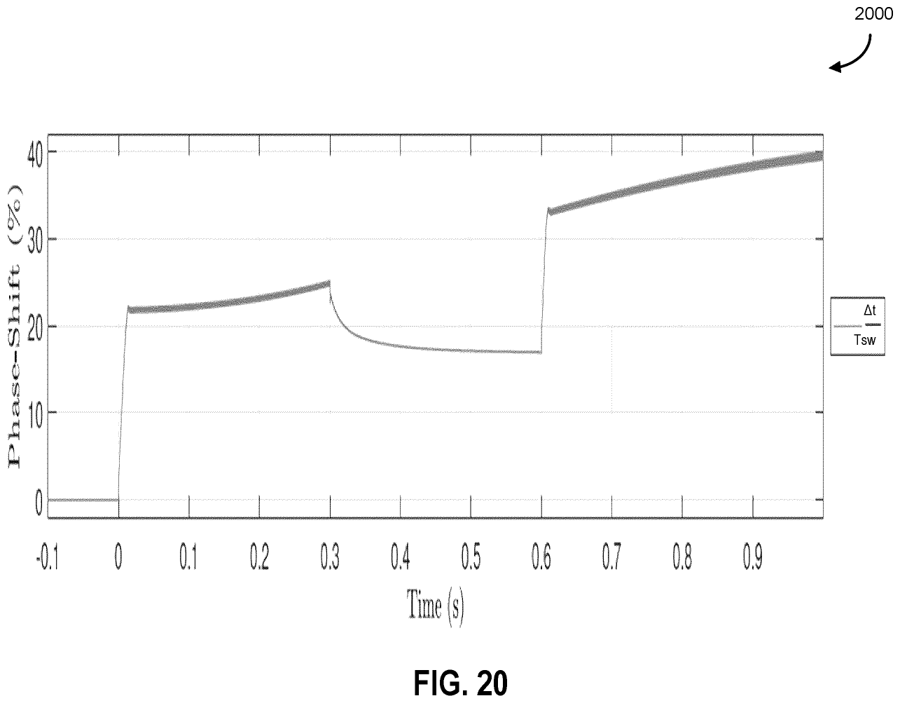

As previously discussed, the mechanism used by the controller 1000 to track the power reference if the application of carrier phase-shift. However, the phase-shift behavior observed in the driving case is slightly different from what was observed during stand-still operation, in particular for accelerating machines. The phase-shift Δt is shown in graph 2000 of FIG. 20. Similarities and differences between the results observed here and in the previous simulation are discussed below.

Similarly to what happened in stand-still operation, as the power reference is increased, the phase-shift 1002 increases to meet the power reference. As the power reference drops, the phase-shift drops. Once again, the phase-shift 1002 is shown to curtail power without necessarily going to 0, as the voltage produced does not meet the reflected battery voltage.

One aspect where the phase-shift 1002 behavior differs from the stand-still case is the fact that it increases as the vehicle accelerates. As the speed increases, the modulation index increases, thereby demanding decreasing the value of A′(M), as shown in FIG. 9, thereby demanding a higher value of Δt to produce the same voltage |\tilde{V}₀⁽¹⁾|, according to (17). At the end of the simulation, the phase-shift 1002 is approximately 40% of the switching period T_{sw}. Another notable difference is that when the power reference is reduced to 0 W, at time t=0.3 s, the phase-shift 1002 does not drop as much as seen in the stand-still case. Once again, the difference is due to the higher modulation index 1006 during driving. With a lower A′(M), a phase-shift value of around 18% of the switching period is sufficiently low to completely cease the power flow.

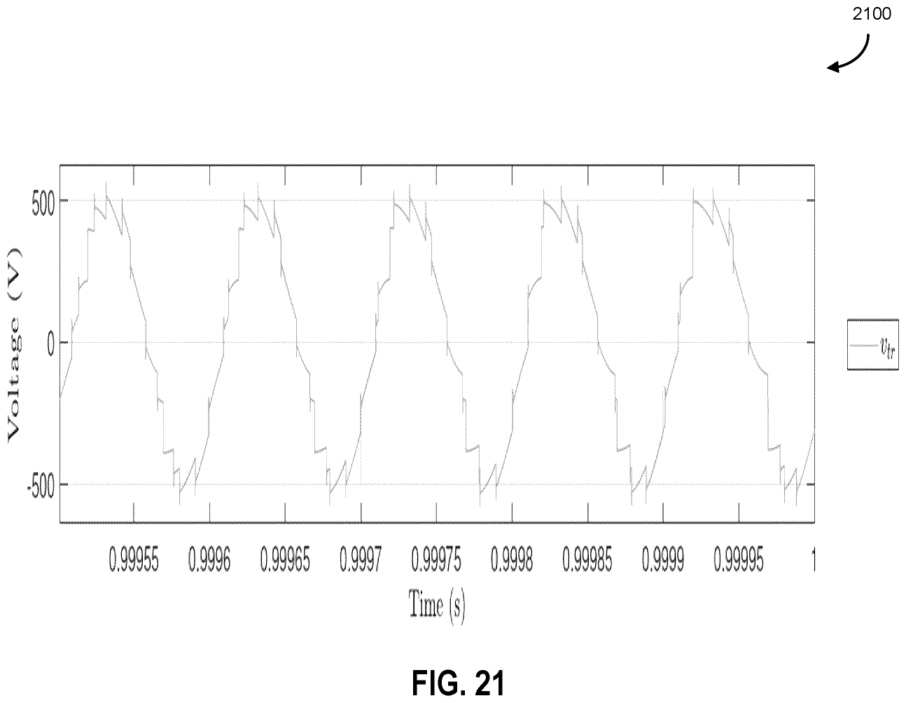

The results showing the voltage across the high voltage terminals of the transformer are shown in the graph 2100 of FIG. 21. The behavior is similar to what is observed in the stand-still case.

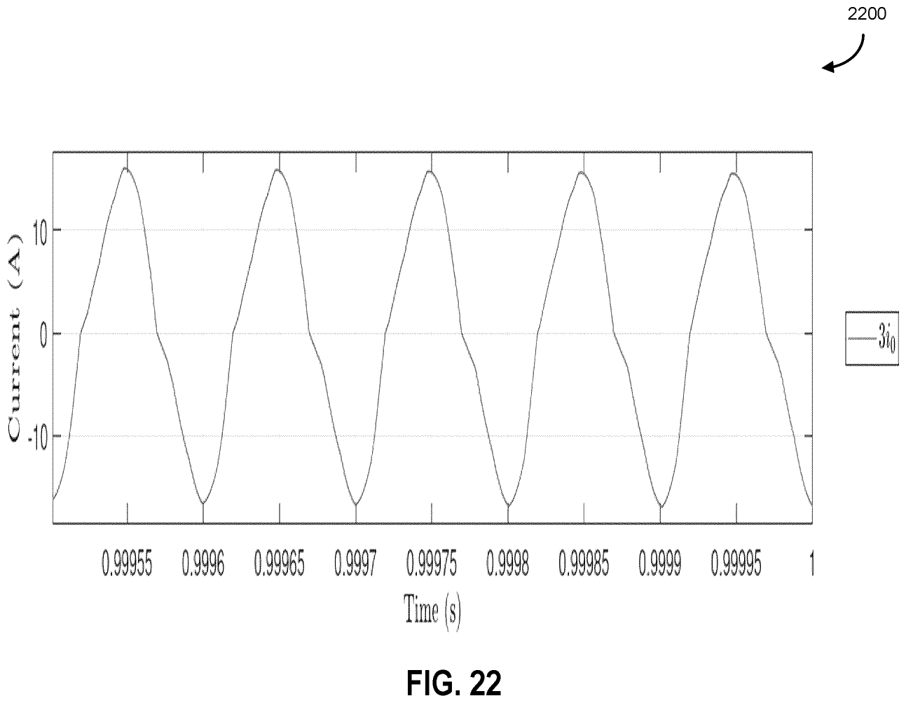

The results showcasing the current through the high voltage winding of the transformer during driving operation are shown in the graph 2200 of FIG. 22. As with the transformer voltage, no significant difference is observed in comparison to the stand-still case.

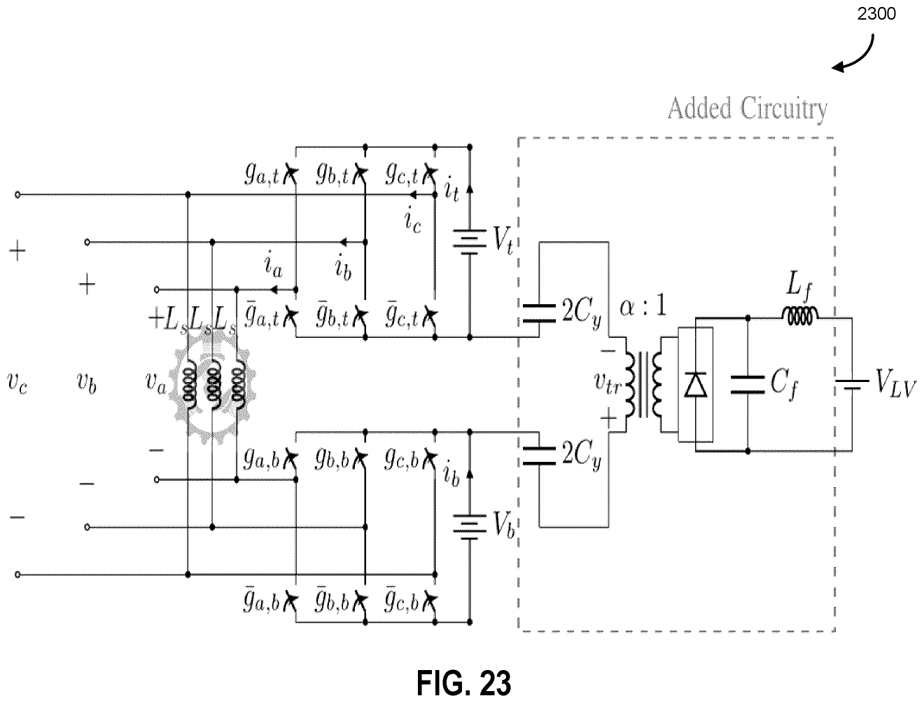

FIG. 23 is an example variation 2300 on a capacitive network, according to some embodiments.

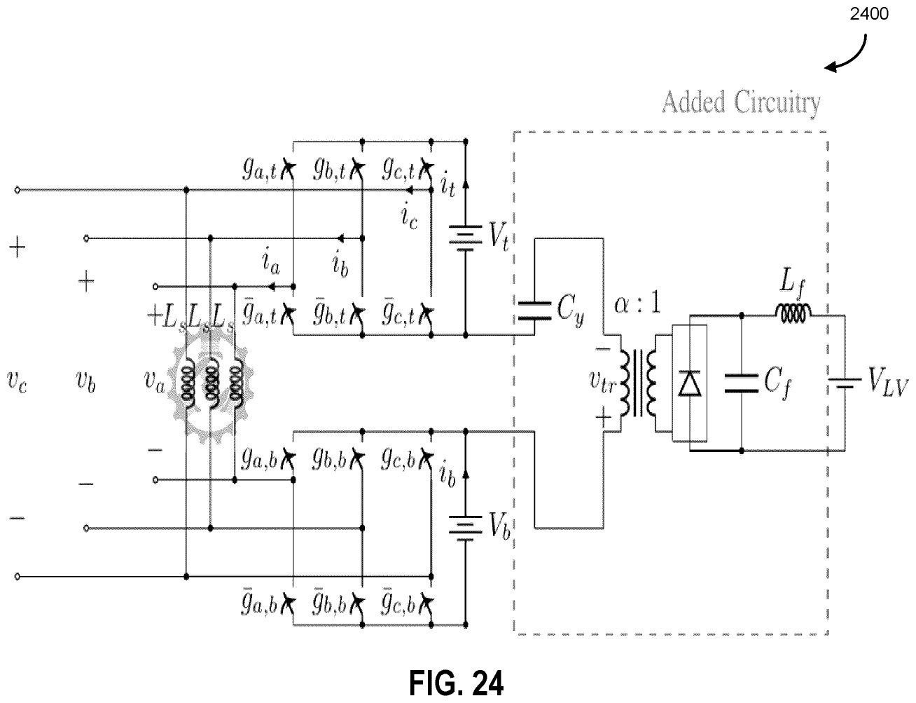

FIG. 24 is a circuit diagram 2400 showing an example variation on a capacitive network, according to some embodiments.

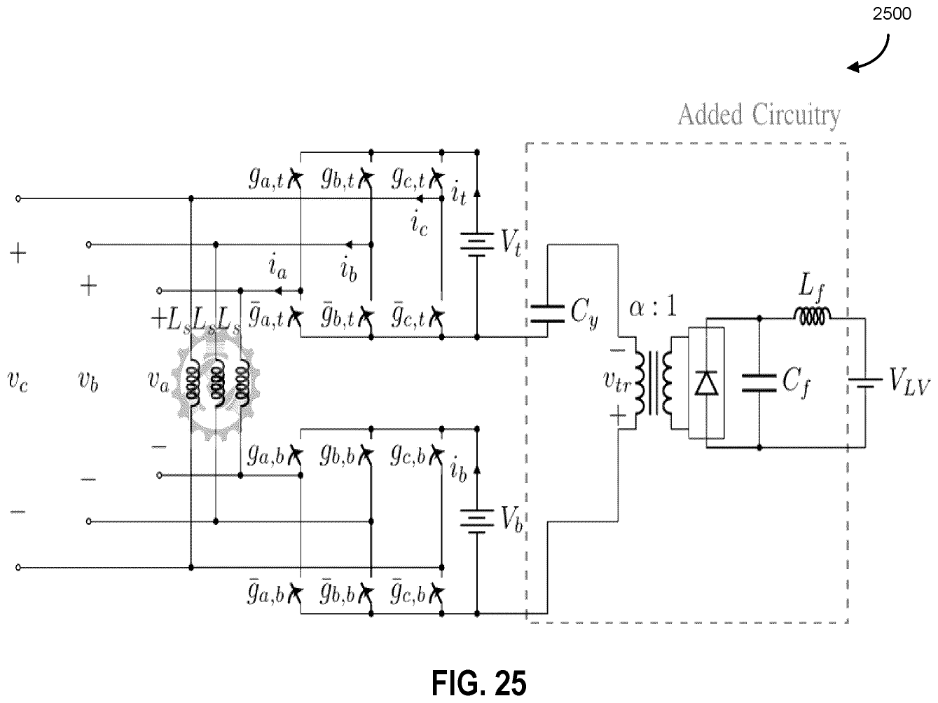

FIG. 25 is a circuit diagram 2500 showing an example variation on a capacitive network, according to some embodiments. Note that a circuit path is different than FIG. 24.

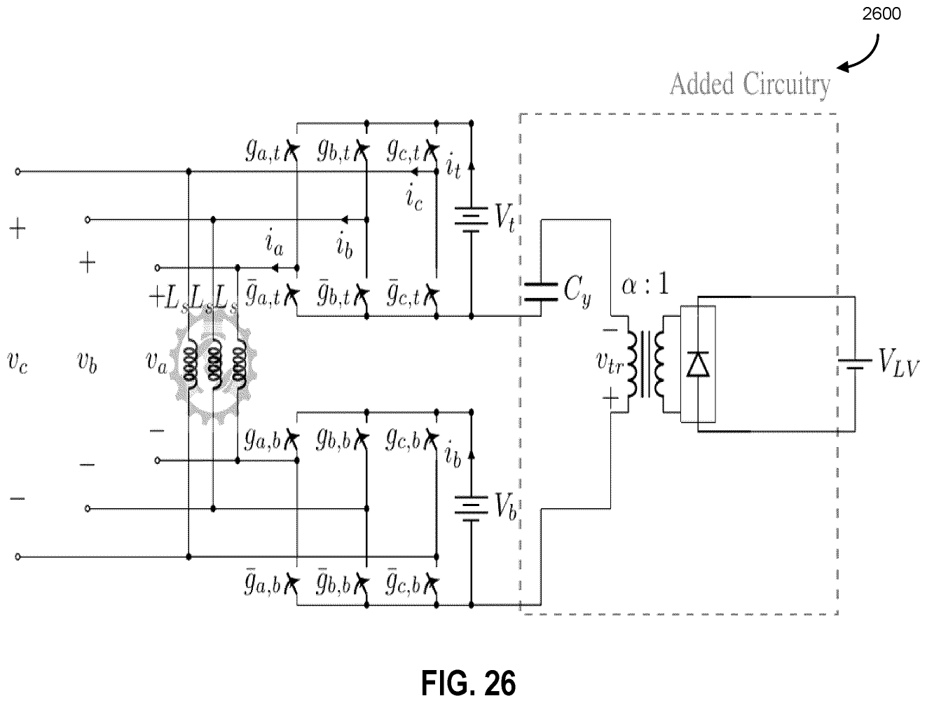

FIG. 26 is a circuit diagram 2600 showing an example variation on a capacitive network, according to some embodiments. In this variation, there is no filter (see Cf and Lf).

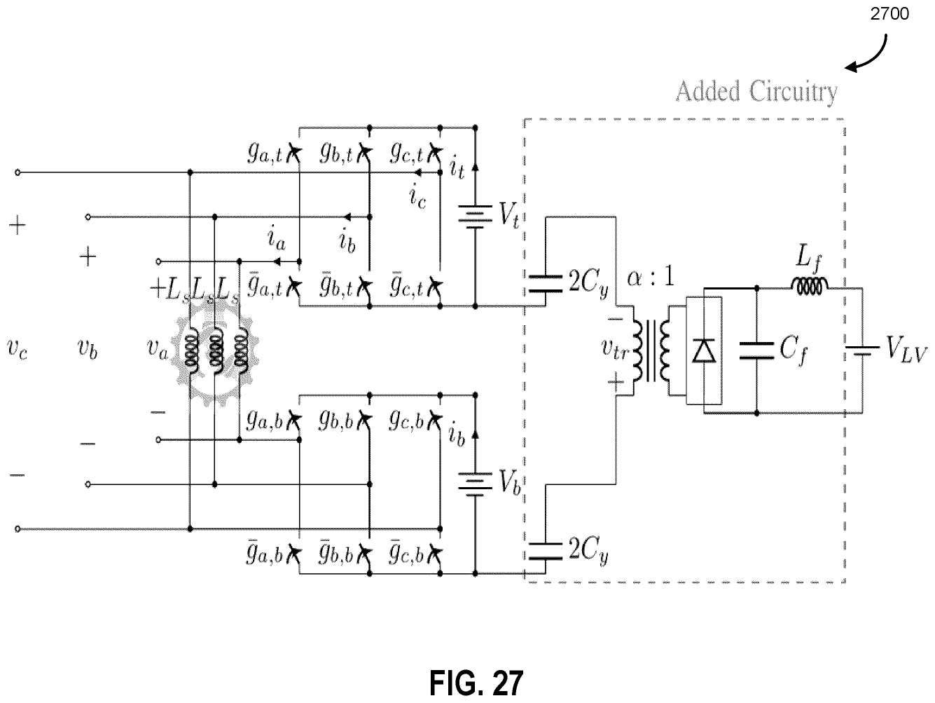

FIG. 27 is a circuit diagram 2700 showing an example variation on a capacitive network, according to some embodiments. In this variation, there is a capacitor in the bottom circuit leg.

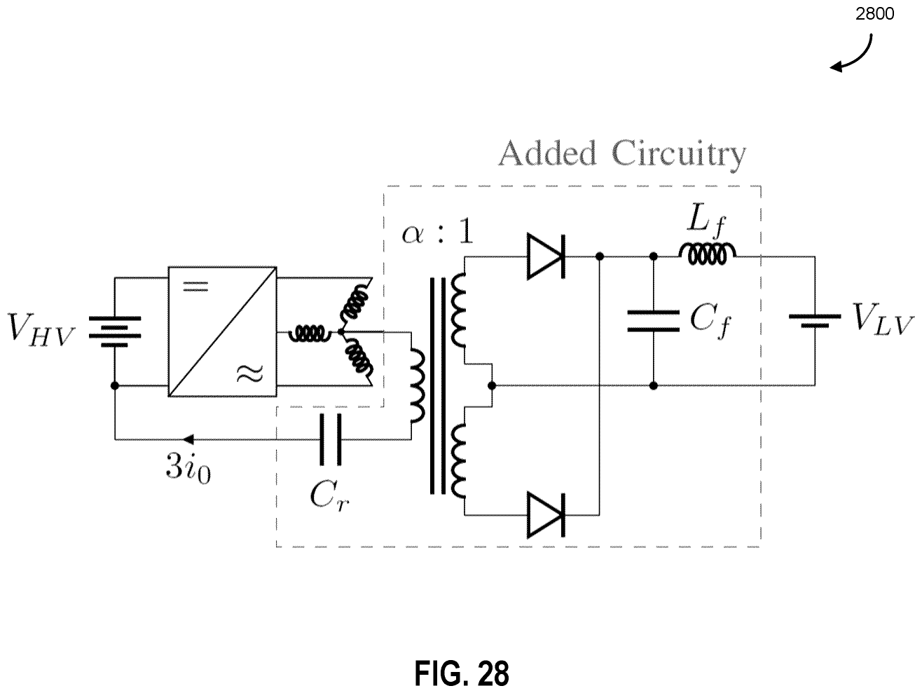

FIG. 28 is a circuit diagram showing a circuit 2800. As shown in 2800, In some embodiments, a proposed solution can include connecting the neutral point of the traction motor to the primary side of the T2A transformer, followed by the compensation capacitor, Cᵣ. On the secondary side of the transformer, a center tapped diode rectifier is connected to a CL filter, followed by the low voltage (LV) battery.

As shown here, an approach is proposed using the circuit for charging the auxiliary energy storage device of an electric or hybrid vehicle with energy coming from the drive inverter energy storage, wherein the method controls the power transfer by controlling the 0-axis voltage applied to the motor, wherein the 0-axis voltage may be the AC component of the open circuit voltage of the neutral point of the driving machine. The 0-axis voltage is controlled by carrier phase-shifts between semiconductors or sets of semiconductors in the drive inverter. The 0-axis voltage can be controlled by carrier phase-shifts between semiconductors or sets of semiconductors in the drive inverter.

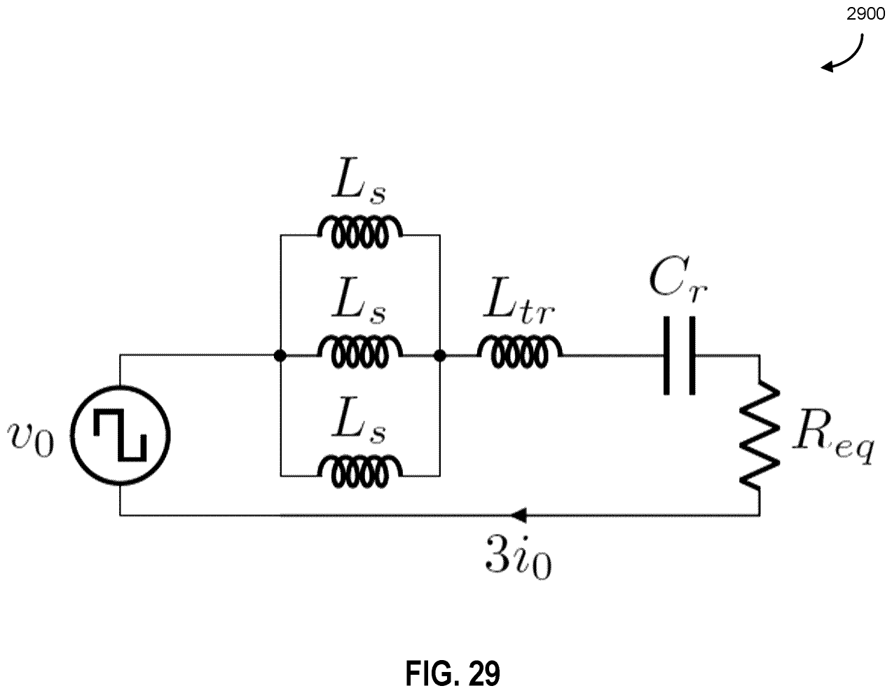

The zero-sequence voltage, v₀, produced by the drivetrain, as described by the Clarke transformation, can be defined as:

$${v}_{0} = \frac{{V}_{HV}}{3} {\sum }_{i = a}^{c} {g}_{i} , \qquad ( 18 )$$

where gᵢ is the gating pulse associated with the top semiconductor-based switch of the leg “i” of the traction inverter, where i∈{a, b, c}. The equivalent circuit representing the associated power transfer, as caused by the circuit in FIG. 28 is shown in circuit 2900 of FIG. 29.

In FIG. 29, Ls represents the zero-sequence (leakage) inductance of the machine, Lₜᵣ represents the leakage inductance of the transformer, referred to the primary side, and Cᵣ is chosen to resonate, at the switching frequency, f_{w}, with the loop inductance.

$${C}_{r} = {( \frac{1}{2 π {f}_{sw}} )}^{2} ( \frac{1}{{L}_{tr} + \frac{{L}_{S}}{3}} ) \qquad ( 19 )$$

With the placement of the compensation capacitor Cᵣ defined by FIG. 29, the resonant nature of the circuit ensures the switching frequency component of the current dominates. Therefore, the power transfer in the circuit is related to the magnitude of the phasor describing the harmonic cluster around switching frequency of v₀, V⁽¹⁾.

$${{V}_{—}}^{( 1 )} = \frac{2}{{T}_{sw}} {\int }_{0}^{{T}_{sw}} {v}_{0} ( t ) {e}^{- j 2 π {f}_{sw}} dt . \qquad ( 20 )$$

In (20), T_{sw} is the switching period,

$$\frac{1}{{f}_{sw}} .$$

The objective of the control system is to control the magnitude of the voltage described in (20) without interfering with the driving operation.

In this embodiment, a PWM modulator synthesizes the machine voltage requested by the drive control to track, for instance, a torque or speed reference. Sufficiently covered in the literature, the drive control is outside the scope of this patent. Note, that the same approach applies even if injection of third harmonic is used to enable higher voltage synthesis.

As in regular drive systems, the space-vector representation of the voltage requested by the drive control is given, as a function of the modulation index, M, and modulation angle, θ, by:

$${{v}^{→︀}}^{*} = \frac{{V}_{HV}}{2} M {e}^{j θ} , \qquad ( 21 )$$

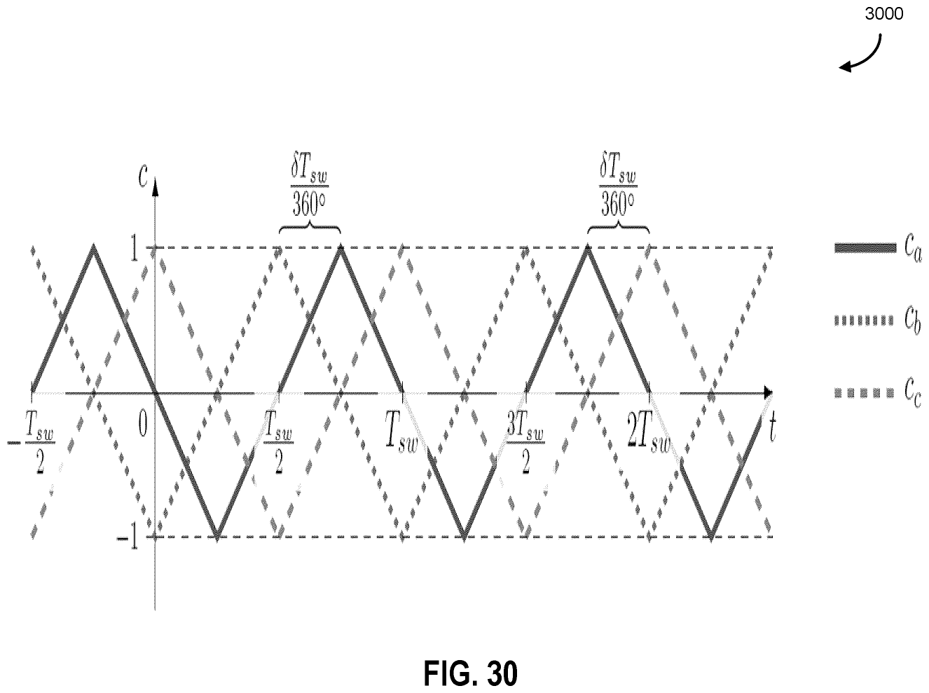

The modulator defines the gating pulses by comparing the modulating signals with an appropriate carrier. To implement the T2A controller, three carriers cₐ, c_{b}, and c_{c}, are defined, such that:

$$[ \begin{matrix}{g}_{a} \\ {g}_{b} \\ {g}_{c}\end{matrix} ] = [ \begin{matrix}M cos ( θ ) > {c}_{a} \\ M cos ( θ - {120}^{\underline{o}} ) > {c}_{b} \\ M cos ( θ + {120}^{\underline{o}} ) > {c}_{c}\end{matrix} ] , \qquad ( 22 )$$

where a controllable phase shift, δ∈ [0°, 120°], is established between carriers, as shown in the graph 3000 of FIG. 30.

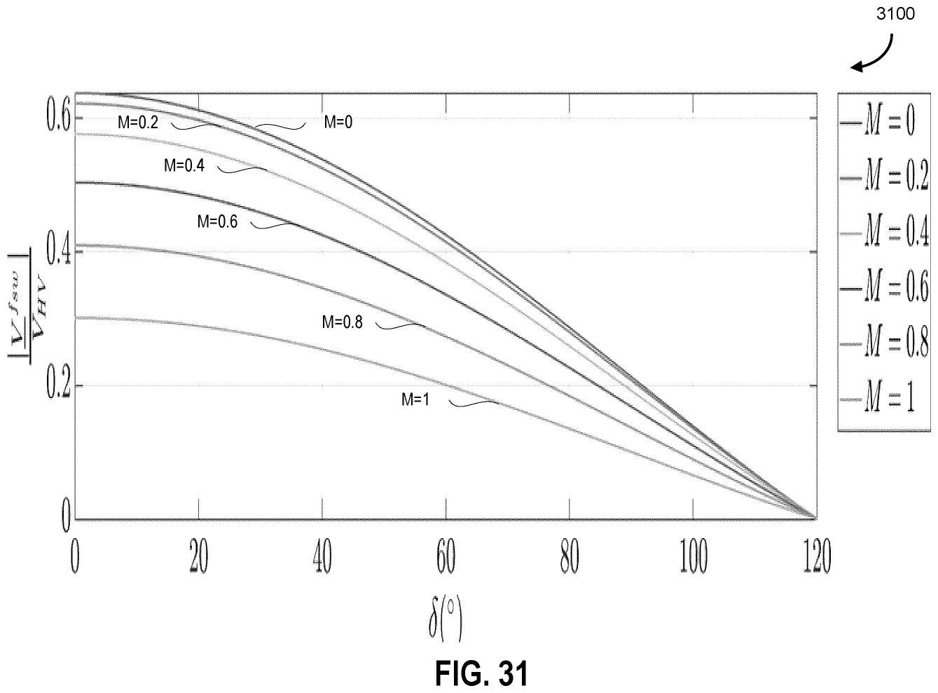

The magnitude of the switching frequency component of the zero-sequence voltage is dependent on carrier phase-shift, δ, and can be shown to be approximately

$$\vert {{V}_{—}}^{( fw )} \vert \approx ( \frac{2 {V}_{HV}}{3 π} ) {J}_{0} ( \frac{M π}{2} ) \vert 1 + 2 cos ( δ ) \vert , \qquad ( 23 )$$

where J₀ is a Bessel function of the first kind. Equation (23) implies that the T2A power transfer can be controlled by varying δ. A value of δ=0° leads to maximum voltage and consequent maximum power transfer, whereas δ=120° brings T2A power output to 0. FIG. 31 is a graph 3100 that shows how the magnitude of the combines frequencies clustered around the switching frequency vary as a function of the modulation index, M, and the carrier phase-shift, δ. Moreover, changing the carrier phase-shift does not affect the line-to-line voltages applied to the machine, hence, the system does not have any effect on the drive operation.

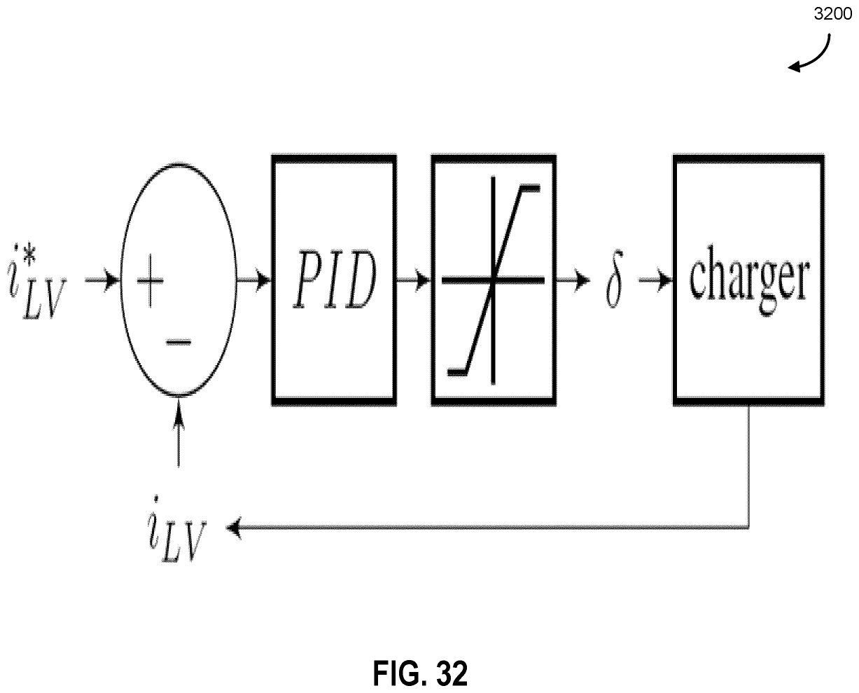

A control system is proposed using a PID controller to correct the value of delta to ensure i_{LV} tracks the associated reference, i_{LV}*. This control loop runs in parallel with the traditional drive control. The T2A control diagram 3200 is shown in FIG. 32. The saturation block ensures 0°≤δ≤120°. Other controllers are possible and a PID controller is used as an example.

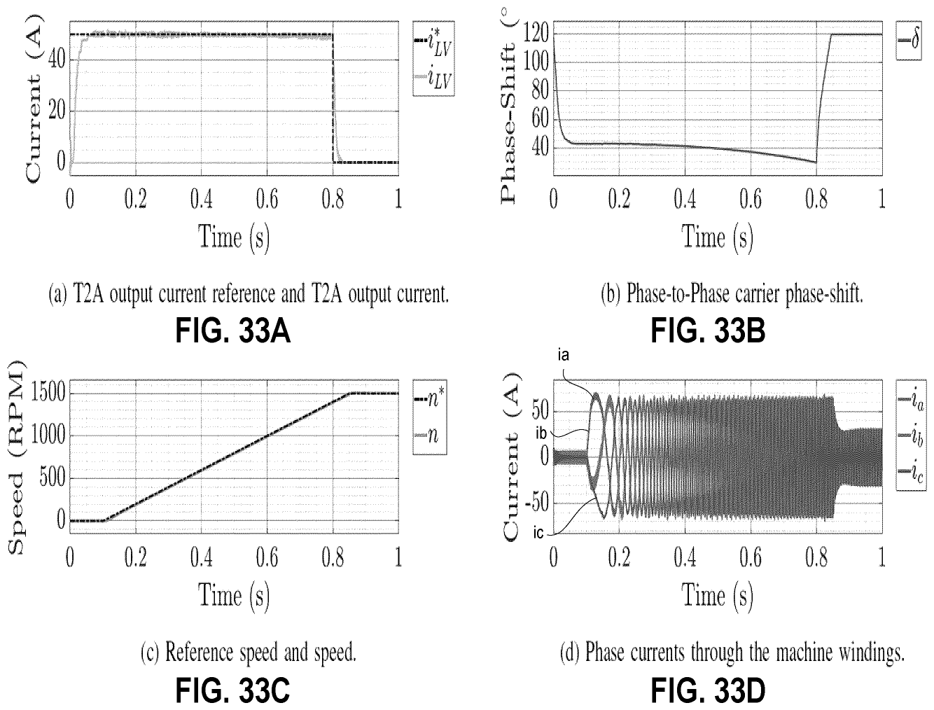

For the sake of elucidation, using the control described in FIG. 32, along with a conventional speed-tracking drive control, the system in FIG. 28 is simulated. The simulation results are shown in FIG. 33A-33D.

At time t=0, the T2A output current reference is set to i_{LV}*=50 A. The system satisfactorily tracks the reference, as shown in FIG. 33A. To achieve T2A power transfer, the T2A controller reduces δ, from 120°, which results in the lowest voltage |V⁽¹⁾|, toward 0°, which results in the highest voltage, as shown in FIG. 33B.

At time t=0.1 s, the speed reference is ramped up to 1500 RPM. The traditional drive control increases the current reference and accelerates the system, tracking the speed reference, as shown in FIG. 33C. Importantly, the current output of the system, shown in FIG. 33D, is unremarkable and similar to what is expected in a regular drive system, demonstrating that the presence and operation of the T2A system do not affect the drive system in any significant way. As the speed increases, the modulation index, M, increases, leading to a requirement of a somewhat lower value of δ to maintain the same power level. This relationship is best seen in FIG. 33B, at 0.5 s<t<0.8 s.

At time t=0.8 s the T2A output current reference is stepped down to 0 A, which the T2A control tracks. Once again, both the T2A operation and transient are demonstrated to not impact the drive control.

An experimental setup is constructed to verify the conclusions made analytically. The experimental setup is comprised of three main parts:
1. The power electronics, semiconductor-based switches, gate drivers, and controls.
2. The permanent magnet synchronous machine and dynamometer, enabling driving operation at a specifiable speed and torque operating point.
3. The T2A added circuitry, including transformer, rectifier, and compensation capacitor.

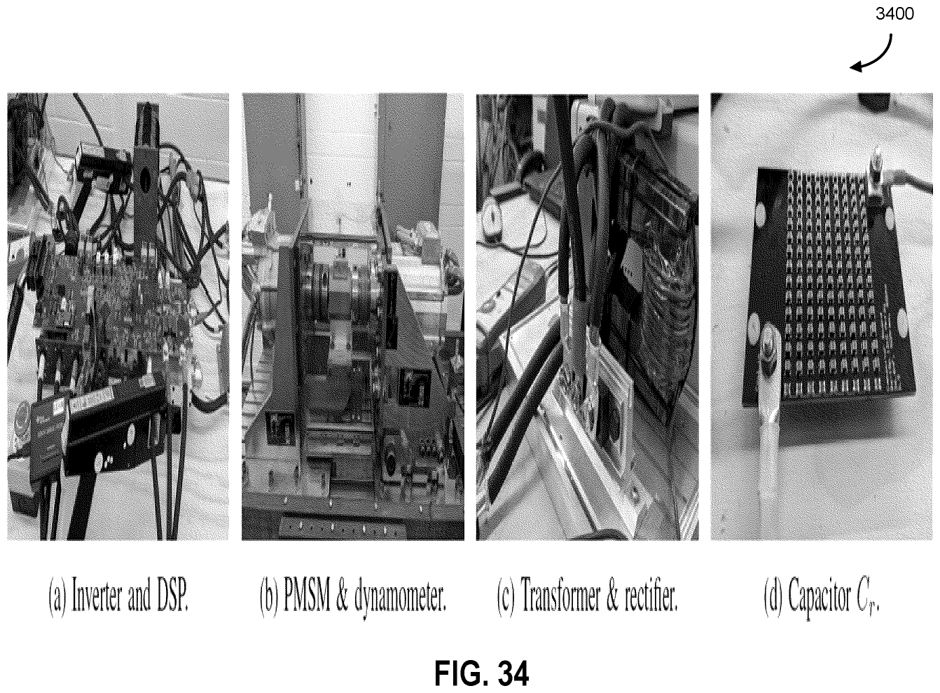

Pictures of the experimental setup are shown in the photographs 3400 of FIG. 34.

The parameters used in this experiment are shown in Table I.

| | | |
|---|---|---|
| Description | Symbol | Value |

System

| | | | |
|---|---|---|---|
| Battery Voltage | Vbatt | 400 | V |
| Auxiliary Voltage | vLV | 6 | V |
| Switching Frequency | fsw | 10 | kHz |

Machine

| | | | |
|---|---|---|---|
| 0-Seq. Inductance | Ls | 0.53 | mH |
| q-axis Inductance | Lq | 0.94 | mH |
| d-axis Inductance | Ld | 0.73 | mH |
| Series Resistance | Rs | 45 | mOhm |
| Flux Linkage | lambda | 0.127 | Wb |
| Rated Current (RMS) | Imax | 200 | A |

T2A

| | | | |
|---|---|---|---|
| Transformer Inductance | Ltr | 700 | uH |
| Compensation Capacitor | Cr | 280 | nF |
| Turns Ratio | alpha | 20 | V/V |
| Filter Capacitance | Cf | 4 | mF |
| Filter Inductance | Lf | 5.37 | uH |

The auxiliary voltage used in this experiment is v_{LV}=6 V, enforced by an electronic load, emulating the auxiliary battery. Note that this is a scaled representation of the 12 V typically used in EVs. This voltage level was selected based on laboratory component availability.

Four experiments are conducted to demonstrate the circuit operation:
1. T2A transient from 0 to 30 A output current reference at standstill.
2. T2A transient from 0 to 30 A output current reference while the drivetrain is operated at 500 RPM and 10 Nm output.
3. Steady-state T2A operation at 0 A output current at standstill.
4. Steady-state T2A operation at 30 A output current at standstill.

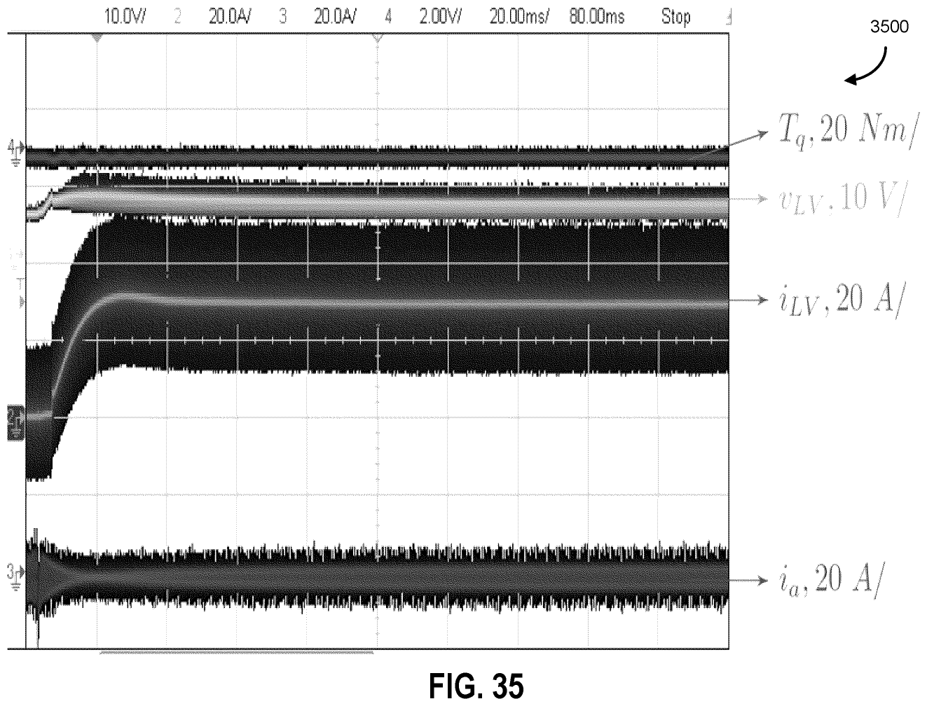

During the first experiment, the drivetrain is set to idle, i.e., to operate at 0 RPM and 0 Nm. With the T2A system initially outputting 0 current, a transient in reference output current, i_{LV}*, is applied from 0 to 30 A. Auxiliary voltage and currents resulting from this experiment are shown in the graph 3500 of FIG. 35. During the transient, the current rises to track the reference. The auxiliary voltage increases slightly, in the presence of current.

During the T2A transient, the current flowing through phase “a” of the machine is measured. The result is shown in FIG. 35. During the transient, the current remains approximately 0.

Using a torque transducer, the torque on the axle connecting the PMSM under test and the dynamometer is measured. The result is shown in FIG. 35. No significant transient can be observed in the torque during the T2A transient. This result suggests that the T2A system, despite leveraging the machine and drive inverter, has no significant impact on the mechanical behavior of the system.

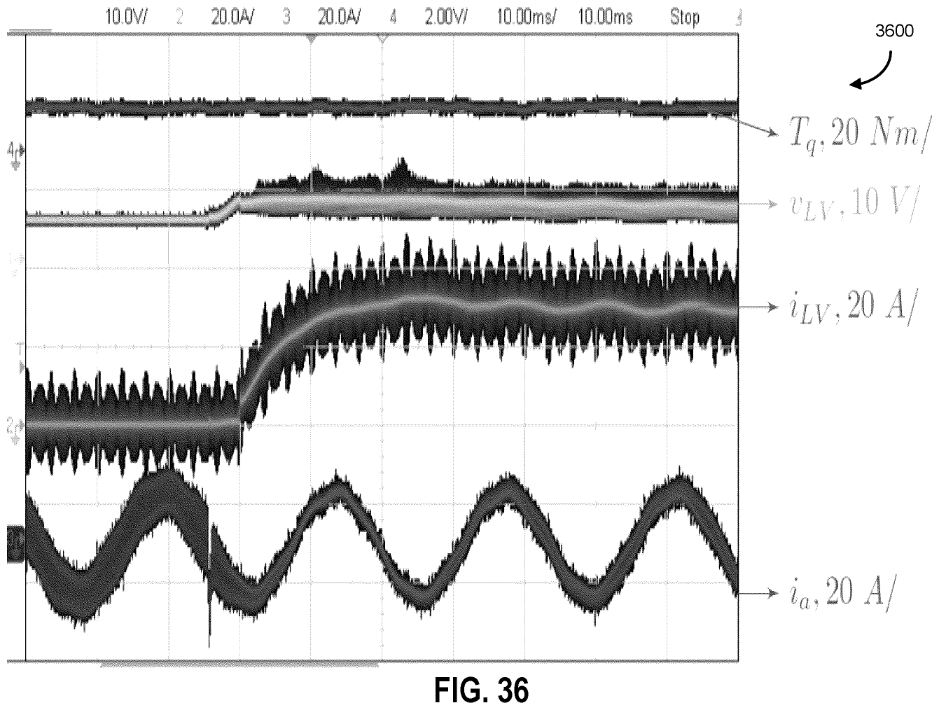

The second experiment explored herein, similarly to the first one, applies a T2A transient in output current from 0 to 30 A. The difference between tests lies in the fact that the drive, here, is set to 500 RPM and 10 Nm. In this setup, the dynamometer is responsible for setting the system speed, while the drivetrain operates in torque control mode. The auxiliary current and voltage waveforms resulting from the procedure are measured and shown in FIG. 36. As was observed in the test at standstill, the current rises to meet the reference, while the auxiliary voltage displays a slight increase.

The current flowing through phase a of the machine is measured during this operation. The result is shown in the graph 3600 in FIG. 36. It can be seen that the current is primarily sinusoidal, as a result of the drive operation. The ripple can be observed to be higher in the portion of the curve where the T2A system is processing zero power. This is the case because to produce i_{LV}=0 A the system applies approximately δ=120° phase-shift, producing a significant line-to-line voltage component at 10 kHz. In contrast, to output i^{LV}=0 A the phase shift is reduced, thereby reducing the line-to-line voltage component but aligning the line-to-neutral currents and voltages of all phases, thus increasing the current through neutral.

While the transient is applied, the measured torque remains at approximately 10 Nm. Once again, no appreciable transient is seen in the torque produced by the system. This result corroborates the analytical conclusion that the T2A system does not interfere with the drive mechanical behavior.

Two more experiments are conducted with the drive system at standstill. These tests aim to show that the system operates with less stator phase current ripple when outputting significant T2A power.

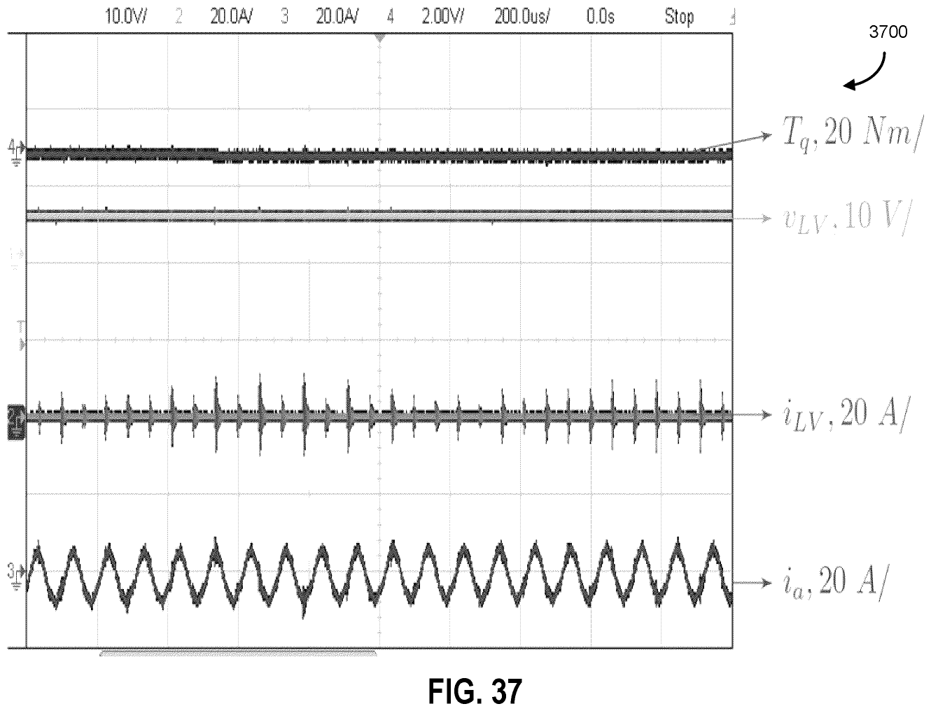

Firstly, the T2A system is set to operate at zero output current, i_{LV}*=0. The machine phase “a” stator current is measured. As shown in the graph 3700 of FIG. 37, the peak current value is around 7.5 A.

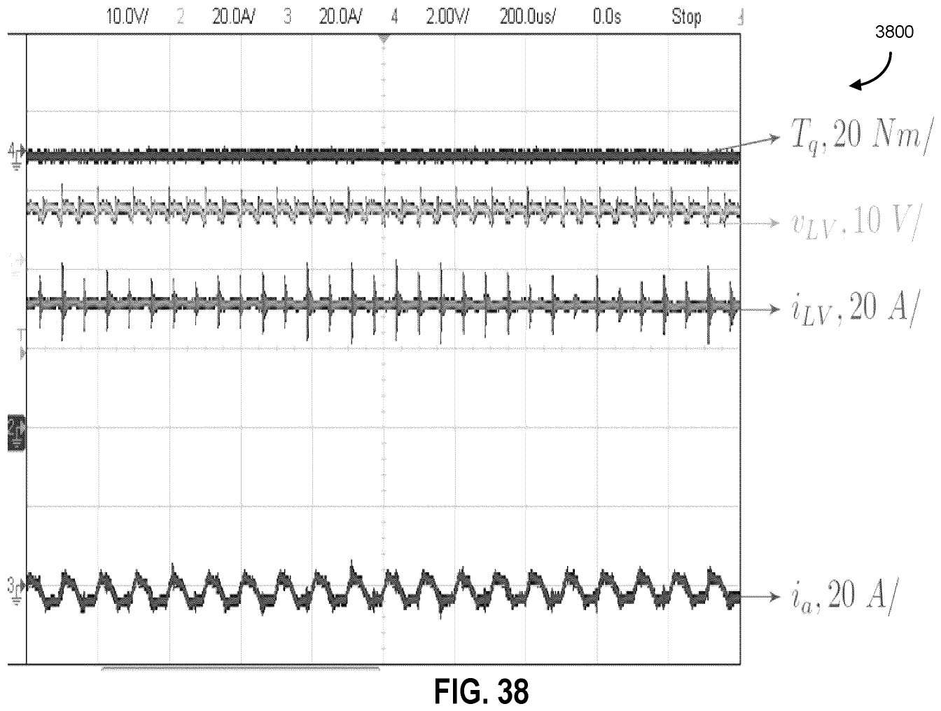

The previous experiment is repeated, but this time with the T2A system outputting i_{LV}=30 A. The graph 3800 in FIG. 38 shows the measured stator phase “a” current. In comparison with the no power case, this scenario produces less phase current ripple, with peak current below 5 A. This phenomenon is explained by the alignment of the phase shift, decreasing the line-to-line voltage seen by the stator. In other words, to output power, the T2A system increases the 10 kHz component of the 0-axis current through the machine, but it reduces the 10 kHz component of a- and p-axis currents more than commensurately, thus reducing the phase current ripple in comparison to the zero output case.

As can be understood, the examples described above and illustrated are intended to be exemplary only and other embodiments may be possible.

Applicant notes that the described embodiments and examples are illustrative and non-limiting. Practical implementation of the features may incorporate a combination of some or all of the aspects, and features described herein should not be taken as indications of future or existing product plans.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended embodiments are intended to include within their scope such processes, machines, manufacture, compositions of matter, means, methods, or steps.

1. A system for transferring power from a first and a second drive inverter energy storage device to an auxiliary energy storage device of an electric or hybrid vehicle through establishing a common mode voltage between the first and the second drive inverter energy storage devices, the system comprising:
a controller circuit including a processor, the controller circuit configured to:
receive one or more data sets representative of an electrical characteristic of the auxiliary energy storage device;
control gating pulses of a first inverter coupled to the first inverter energy storage device and a second inverter coupled to the second drive inverter energy storage devices to introduce a phase shift between the operation of the first inverter and the second inverter, the phase shift implemented using a delay between carriers of the gating pulses of the first inverter and the second inverter; and
control the phase shift based on the electrical characteristic of the auxiliary energy storage device to control an amount of power provided to the auxiliary energy storage device from the first and second inverter energy storage devices through an introduced fundamental 0-axis voltage harmonic.

2. The system of claim 1, wherein controlling the phase shift includes utilizing a feedback loop to zero a power error based on a current modulation index as set by a (Original) driving control system.

3. The system of claim 2, wherein the current modulation index is dependent at least on a speed of operation of the vehicle.

4. The system of claim 3, wherein the phase shift is increased when the vehicle is operating at higher driving speeds relative to when the vehicle is operating at lower driving speeds.

5. The system of claim 1, wherein the phase shift is adapted to provide a maximum applicable voltage given the electrical characteristic of the auxiliary energy storage device.

6. The system of claim 2, wherein the feedback loop is provided using a PI controller.

7. The system of claim 1, wherein the electrical characteristic of the auxiliary energy storage device is a charge level of the auxiliary energy storage device.

8. The system of claim 3, wherein the modulation index is approximately 0 during standstill operation of the vehicle.

9. The system of claim 1, wherein the controller circuit is configured to filter a high frequency component using a LC filter.

10. The system of claim 1, wherein the controller circuit is configured to switch gates of the first inverter and the second drive inverter.

11. A method for transferring power from a first and a second drive inverter energy storage device to an auxiliary energy storage device of an electric or hybrid vehicle through establishing a common mode voltage between the first and the second drive inverter energy storage devices, the method comprising:
receiving, one or more data sets representative of an electrical characteristic of the auxiliary energy storage device;
controlling gating pulses of a first inverter coupled to the first inverter energy storage device and a second inverter coupled to the second drive inverter energy storage devices to introduce a phase shift between the operation of the first inverter and the second inverter, the phase shift implemented using a delay between carriers of the gating pulses of the first inverter and the second inverter; and
controlling the phase shift based on the electrical characteristic of the auxiliary energy storage device to control an amount of power provided to the auxiliary energy storage device from the first and second inverter energy storage devices through an introduced fundamental 0-axis voltage harmonic.

12. The method of claim 11, wherein controlling the phase shift includes utilizing a feedback loop to zero a power error based on a current modulation index as set by a driving control system.

13. The method of claim 12, wherein the current modulation index is dependent at least on a speed of operation of the vehicle.

14. The method of claim 13, wherein the phase shift is increased when the vehicle is operating at higher driving speeds relative to when the vehicle is operating at lower driving speeds.

15. The method of claim 11, wherein the phase shift is adapted to provide a maximum applicable voltage given the electrical characteristic of the auxiliary energy storage device.

16. The method of claim 12, wherein the feedback loop is provided using a PI controller.

17. The method of claim 11, wherein the electrical characteristic of the auxiliary energy storage device is a charge level of the auxiliary energy storage device.

18. The method of claim 13, wherein the modulation index is approximately 0 during standstill operation of the vehicle.

19. The method of claim 11, further comprising filtering a high frequency component using a LC filter.

20-52. (canceled)

53. A non-transitory computer readable medium storing machine interpretable instructions, which when executed by a processor, cause the processor to perform a method for transferring power from a first and a second drive inverter energy storage device to an auxiliary energy storage device of an electric or hybrid vehicle through establishing a common mode voltage between the first and the second drive inverter energy storage devices, the method comprising:
receiving, one or more data sets representative of an electrical characteristic of the auxiliary energy storage device;
controlling gating pulses of a first inverter coupled to the first inverter energy storage device and a second inverter coupled to the second drive inverter energy storage devices to introduce a phase shift between the operation of the first inverter and the second inverter, the phase shift implemented using a delay between carriers of the gating pulses of the first inverter and the second inverter; and
controlling the phase shift based on the electrical characteristic of the auxiliary energy storage device to control an amount of power provided to the auxiliary energy storage device from the first and second inverter energy storage devices through an introduced fundamental 0-axis voltage harmonic.
